(19) United States
(12) Patent Application Publication
(10) Pub. No.: US 2013/0036040 A1
(43) Pub. Date: Feb. 7, 2013

(54) METHOD AND SYSTEM FOR FINANCING THE GRADUAL ACQUISITION OF QUOTAS OF AN ESTATE

(71) Applicant: Michele GIUDILLI, Mattinata (FG) (IT)

(72) Inventor: Michele GIUDILLI, Mattinata (FG) (IT)

(21) Appl. No.: 13/567,170

(22) Filed: Aug. 6, 2012

Related U.S. Application Data
(60) Provisional application No. 61/515,268, filed on Aug. 4, 2011.

(51) Int. Cl. G06Q 40/00; G06Q 40/04

(52) U.S. Cl. 705/37; 705/39

(57) ABSTRACT

A method for implementing a gradual acquisition plan on the part of a purchaser of an estate which is registered in the name of a legal entity represented by quotas; the quotas are transferred by the bank, owner of the legal entity holder of the estate, to the purchaser, according to a certain gradual reacquisition plan; the method includes reacquisition phases on the part of said purchaser of quota or portions of it through the payment, to the bank, of monthly installments, each including the quota value and relative interest; said quotas can be exchanged by an electronic system in order to exchange the estate with another property by mean their respective legal entity.

### RELATED APPLICATIONS

This non-provisional U.S. patent application is claiming the benefits of the U.S. Provisional Patent Application Ser. No. 61/515,268 filed on Aug. 4, 2011.

### BACKGROUND OF THE INVENTION

At present, when a person intends to purchase a property for residential purposes, he has different options if he does not possess the necessary amount of money for purchasing it, such as opening a mortgage or signing an estate leasing contract. Otherwise, the most economical way of having a house is to rent it, with the disadvantage that the money paid cannot be recovered and consequently it will never be possible to own the house.

Even if the industry of mortgages is currently flourishing and consolidated, the principle on which mortgages are based is the possibility, on the part of the borrower, of coping with the monthly payments of the mortgage installments and a require a stable framework of interests rate which does not allow the amount of the installment to be excessively increased, in the case the loan is at a variable interest rate. During the financial crisis in 2008, however, numerous people, unable to pay their installment, were forced to have their houses sold on auction (foreclosure), often losing the accumulated value of the house, in order to face their debts with respect to the bank, especially in a market with decreasing prices as is currently the case. Furthermore, the massive use of “mortgages” which become the collateral on which securization operations are effected, is in itself a debt-conceived instrument which can generate a risk when borrowers do not pay the installments or if a decrease in property prices lowers the price of houses and consequently increases the LTV (Loan to value ratio) mortgage values. These elements have contributed to triggering the crisis of subprime loans, i.e. loans granted to persons with a low income, who are not able to pay the monthly installments due to an increase in the interest rate.

Social categories consisting of low-income workers, precarious workers, immigrants, in the light of the consequences of the present crisis, will have difficulty in purchasing a house, as it is assumed that in the future there will no longer be subprime loans and consequently they will be forced to pay a rent to house owners, without the possibility of fulfilling their “American dream”. Another limitation of present traditional financing instruments is that, in case of moving or being transferred, for professional or personal reasons, to another area of the city or to another city, a house owner who has a mortgage must sell his house, pay the remaining debt and buy another house in the new area or city, starting a new mortgage. The current financial systems for purchasing a house are rigid and make the property title of the house “immovable”, when American society has always been characterized by a great mobility of citizens within the whole national territory. A solution capable of making the possession of a house more “personal” would be highly appreciated, with a flexible purchase plan, no longer based on the concept of “debt” but on that of “equity” where house ownership is represented by a variable number of quotas and with a gradual acquisition system.

As prior art of this method, the following can be considered: Islamic finance and the leaseback contract. Islamic finance is finance according to the rules of the Koran, whose practices are used by all believers and by financial institutions. The basic principle of Islamic finance is the prohibition of imposing interest, as this is against the principles of Islam. In order to avoid the application of interest as such, financial techniques are applied which allow certain financial operations to be implemented without acting against religious prohibitions. For financing the purchase of an estate, for example, the financer does not grant a loan with interest to the house owner, creating a mortgage, but shares the risk, maintaining the ownership of the estate and allowing its re-acquisition once all the monthly installments have been paid.

As will be seen, the present method derives from Islamic finance but with a new modernized conception, suitable for the social and financial culture of Western countries and the US market, which envisages the payment of interest, allows the immediate securization (i.e. transformation into Securities and exchangeable titles) of the estate and allows a certain gradualness in the acquisition of the property.

The other prior art is represented by the leaseback contract. In this case, the owner of an estate grants said estate to a financing subject and the latter, through a leasing contract, allows the prior owner to use the estate and purchase it through a leasing contract and, only at the end of the payment of the installments, to redeem it. The difference between the present method and leaseback together with the praxis of Islamic finance, is linked to the transfer of quotas of the property as they are paid and not at the end of the contracts as in the two cases of the prior art mentioned above. In this way, as the monthly payments are effected, some quotas of the property are transferred to the owner from the financer's account.

### DESCRIPTION OF THE DRAWINGS

The method here presented will be best understood by reference the following drawings and detailed description

FIG. 1 is a schema of the subject and the flow between customer, bank and monthly obligation.

FIG. 1a. is a block diagram with the main procedure of the method here exposed.

FIG. 2 is a schema of the means involved in the producing document based on the present method.

FIG. 3 is a block diagram with the procedure to calculate quota value and the routine apply to the method.

FIG. 4 is a graph that shows how the quotas property changes during the life of the gradual acquisition plan.

FIG. 5 is a block diagram that show the monthly quota transferring apply by the method base on the successful of not of monthly installment.

FIG. 6 is a block diagram where show a further implementation based on the conversion of a mortgage loan into a plan under this method.

FIG. 7 is a schema that depict the subject involved in a online marketplace based on the quotas and plan of this invention.

### SUMMARY OF THE INVENTION

An objective of the present invention is therefore to develop a new financing system for the purchasing of a house, through a system which is accessible in terms of acquisition and does not require a preponderant evaluation of the credit score, allows the gradual acquisition of the property quotas of the house and, at the same time, allows a strong social mobility, i.e., in the case of transferral from one city to another, it allows the owned quotas of a house to be transferred and used for the purchase of another house. At the same time, to offer the possibility of utilizing and accumulating property quotas of an estate and consequently to accumulate a capital represented by the house.

A further objective of the present invention is to offer a solution to the problem of toxic assets owned by banks during the present financial crisis. As is known, the present financial crisis was generated by the loss of value of financial instruments (CDO, ABS) based on mortgages and on future payment flows on the part of debtors of the subprime type, i.e. with low credit merit requirements. Due to the end of the estate market rush, the prices of houses have decreased and this has caused a deterioration and loss in the value of so-called toxic titles, and this loss in value has led to serious losses in bank accounts due to the so-called mark-to-market time-discounting principle. Consequently a particular implementation of the method of the present invention allows the conversion of toxic assets based on debt, mortgage values and the capacity of reimbursing debts into equity which is not based on a debt, but on the value of the property. In this way, by converting present mortgages, which represent a debt of the borrower towards the bank, into ownership plans of the house, according to the present invention, it is possible to save the accounts of many banks, reduce private borrowing and foreclosure procedures allowing an easy acquisition of the estate according to the following plan, through the gradual acquisition of the ownership of the property. In particular, banks can convert mortgages into reacquisition plans based on quotas according to the present invention, which means that they will no longer have credits towards the clients, but the amount of the plans (i.e. the ownership quotas of the properties) would be registered in their account among the financial fixed assets. In this way there is the advantage that, if a client is in arrears, the bank would not proceed with a devaluation of the credit, as in traditional mortgages, but, on the contrary, would obtain an increase in its fixed assets, as the client in arrears would lose the relative accumulated quotas of the estate during the months in which he paid, until, if the default should persist, eviction measures are effected, or a new tenant found for the same estate, according the same plan. Whereas a loan in default represents a loss of the entire credit for a bank, until the same is recovered by the sale of the property (which could occur at a lower price), if the following plan is used, in the case of default on the part of the client, the financial asset represented by the quotas owned by the bank would not suffer devaluation, as the property is de facto owned by the bank and can easily find a new client starting a new plan based on the present method, in order to acquire the ownership of the house, without the financial burden of a mortgage and an increase in personal debts.

House owners who have stipulated a mortgage loan and have problems in paying the installments, can, thanks to a particular implementation of the present method, convert the loan into a plan, according to the present method, based on quotas which can be gradually repurchased.

### DESCRIPTION OF THE INVENTION

The method described herein allows financial documents to be created, through the use of a computerized system, which allows the ownership of an estate to be represented as quotas, through the subdivision of its value into a certain number of ownership quotas, the value of each quota, the cost of each monthly installment; this method creates a system which allows the gradual re-acquisition of the property and favours the exchange of these quotas between the interested subjects, through a computerized system and the use of internet.

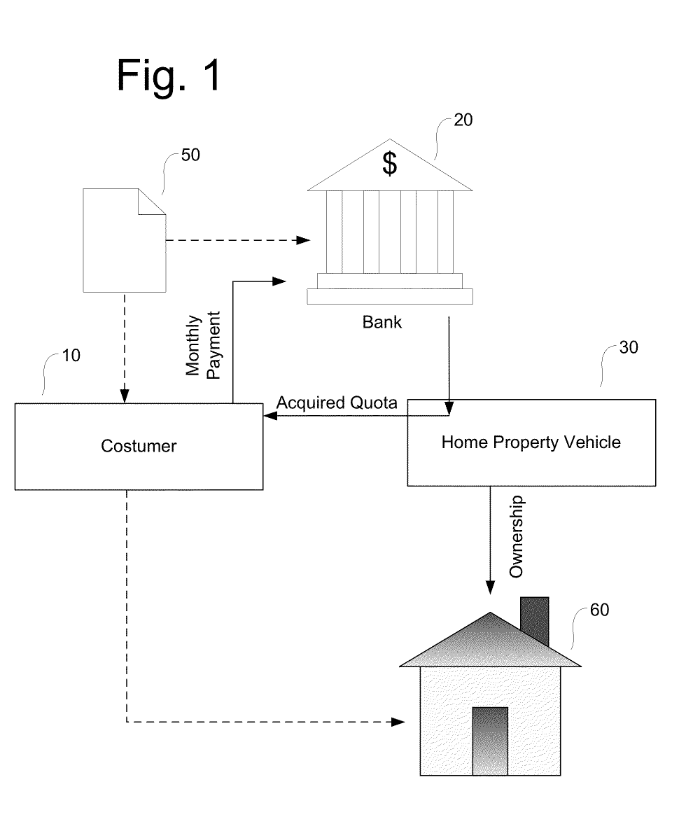

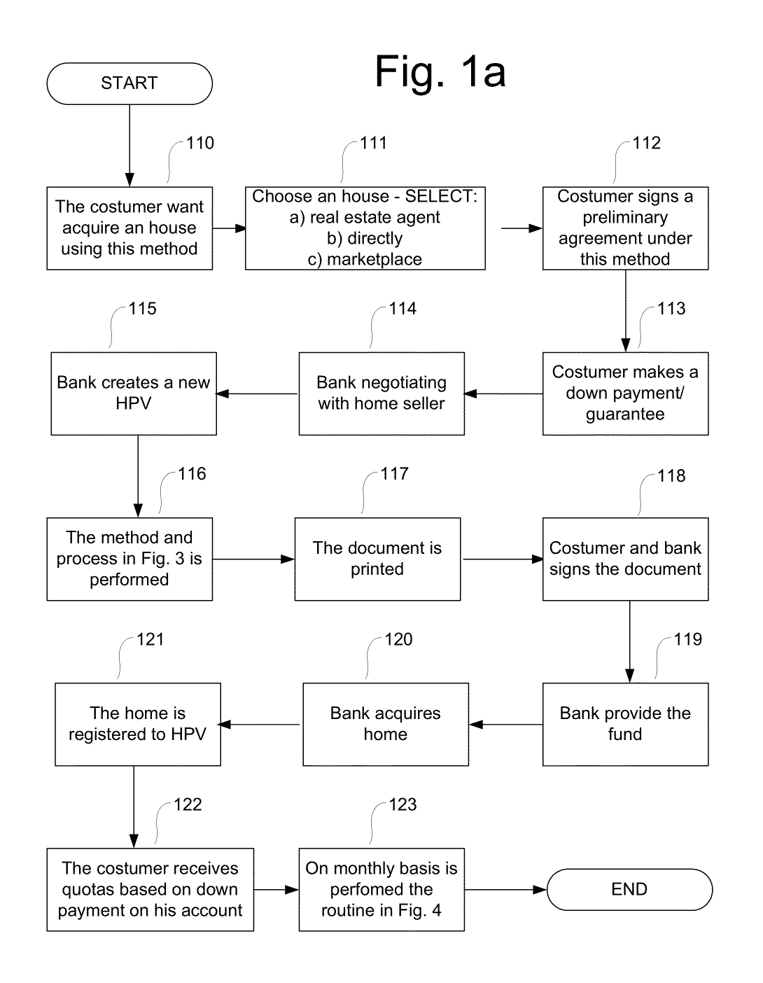

FIG. 1 shows a scheme of subjects involved. In order to implement this gradual reacquisition system and achieve the objectives of the invention, it is necessary that the ownership quotas do not directly refer to a certain property, but the ownership of the latter must be a legal entity which we will call House Propriety Vehicle (HPV)(30). A (HPV)(30) is a legal entity such as a LLC (Limited Liability Company) in whose name the ownership of the estate is registered. A client (10) who wishes to use this method and system turns to a bank (20) or a financial company, and the bank which implementing the present invention, buys the estate (60). The house is registered in the name of a HPV and, by means of a suitable contract (50)—effected through a PC (40) and a printer (41)—a commitment is established between the future house-owner and the bank to implement the method and acquisition system of the house described herein, i.e. the house-owner accepts to purchase each month from the bank, a fraction or quota of this HPV: as the HPV is the owner of the estate, it is therefore the same as purchasing a quota of the house. This quota is equal to, or mainly equivalent to, the capital portion of a long-term mortgage (from 10-15 to 30-40 years) amortized according to the French method. The payment of the installment grants the right to use the estate (as if it were rented) and also allows the entire value of the capital part of the installment to be accumulated into quotas or fractions of the HPV house-owner. The bank undertakes, against monthly payments, to transfer said quota or fraction of the HPV to the owner according to the present method, by means of a computerized accounting system or by transferring paper documents to the clients.

The number of quotas of the HPV depends on how the value of the house is to be divided up and, even if it can be arbitrary, is defined on the basis of the number of years of duration of the reacquisition plan of the house/HPV according to the present invention. If we consider that an owner wishes to purchase the house in 30 years, then the HPV will be split into 360 quotas, each corresponding to a month. Therefore, for a house having an acquisition value of $360,000 each quota will have the starting value of $1,000. The purchaser, future owner, can establish whether he intends to immediately purchase a certain number of quotas of the HPV/house. This corresponds to down payment which is effected in a traditional mortgage contract, in order to reduce the amount financed. If the client decides, for example, to buy 60 quotas effecting a down-payment of $60,000, the remaining portion to complete the acquisition of the property will be disbursed by the bank which will acquire 300 quotas of the HPV owner of the estate, for an amount of 300,000$. It is as if the owner were receiving a loan from the bank of 300,000$ to allow him to purchase the quotas he does not possess. The bank, in fact, is not granting a loan to the client/owner, as it has already acquired the quotas (300 for $300,000) but is simply applying a return plan as if it were a loan, using the same calculation parameters applying a French amortization: starting capital, monthly installments, interest rate, using a computer. The resulting monthly installment is the installment to be paid by the client/owner to the bank, the capital part of said installment corresponds to the quota or fraction of the HPV, whereas the interest is the remuneration of the capital required by the bank as it has financed the purchase of the house using the system of HPV's quotas.

Table 1 represents a synthesis of the main data of a plan referring to an estate having a value of 360,000$ with a down-payment of 60,000$, an interest rate of 6% and 360 quotas having a unitary value of 1,000$, of which 60 are initially acquired by down-payment and the remaining 300 must be financed. This plan envisages a monthly installment of 1,798$ calculated with a financial amortization.

TABLE 1

| | |
|---|---|
| Interest Rate | 6% |
| Property value | 360,000$ |
| Year/months repayment | 30/360 |
| Quota Issued Number | 360 |
| Quota Value | 1,000$ |
| Down Payment | 60,000$ |
| Financing Quota Number | 300 |
| Financing Amount | 300,000$ |
| Initial Quota Value | 1,000$ |
| Quota Number acquired w/down payment | 60 |
| Monthly payment | 1,798$ |

It is also possible to acquire the property, according to the present system, with no down payment, so that the bank finances 100% of the quotas.

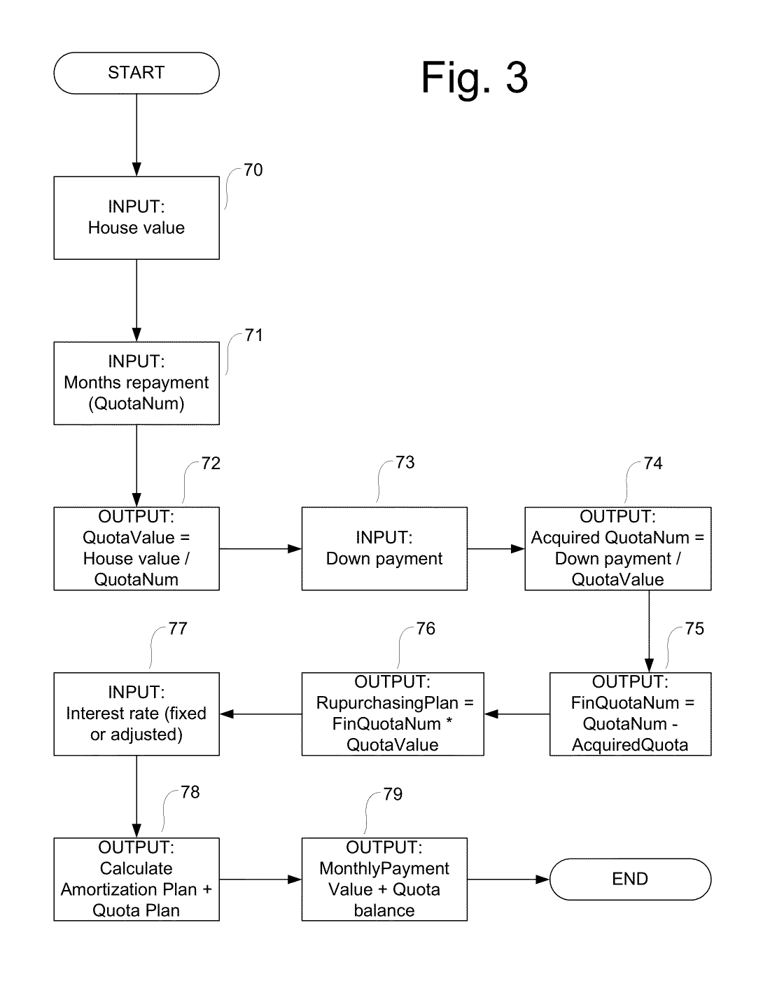

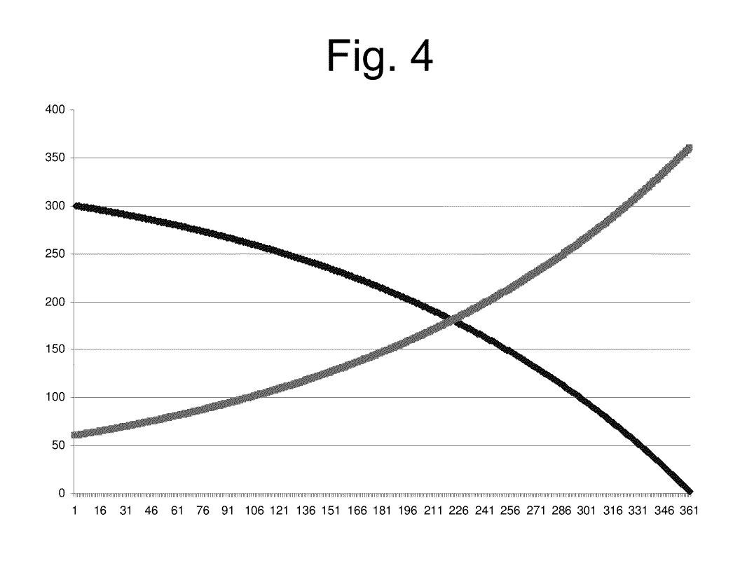

FIG. 1a shows the method at the basis of the present patent, as a block diagram with a preferential procedure of the method. It will be evident to an expert in the field how to vary this procedure, also by changing the order, without losing the objective and efficacy of the present invention. With 110 the client decides to purchase a new house using the present method and acquisition system, he selects a house (111) through the intervention of a real estate agent, either directly or using the marketplace envisaged in the present invention. Once the estate has been found, the client signs (112) a preliminary agreement with a bank with the undertaking to purchase the estate according to the plan, in 113 the client makes a down payment or guarantee, in order to allow the bank to negotiate with the property seller (114), then, in the case of a positive result and agreement, the bank creates a new HPV (115), and the method (116) is effected, as indicated in FIG. 3, the document (50) is printed, bank and client sign (118) the document which regulates the acquisition of the property and the reacquisition plan of quotas according to the present method. The bank supplies the remaining amount of money corresponding to the quotas in its possession (119) with which it will acquire the estate (120) together with the down payment, said estate is registered in the name of the HPV (121). The client receives a number of quotas on the basis of what has been established by the reacquisition plan (122) and the method-routine (123) indicated in FIG. 4 is applied monthly.

In addition to facilitating the acquisition of a house, this method and system does not create any risks for the bank and offers advantages with respect to the bank's balance sheet.

In traditional loans, the bank lends money to a client so that he can purchase a house, receiving, as guarantee, a mortgage on the estate.

Table 2 shows a brief accounting entry of a traditional loan with the assets and liabilities part of the balance.

TABLE 2
Mortgage value $200,000
Bank balance sheet (value in $)

| | |
|---|---|
| Assets | Liabilities |

| | | | |
|---|---|---|---|
| Loans | 200,000 | Deposits, other liabilities | 200,000 |

The loan is registered in the “loans” in the part relating to assets, whereas, as financial coverage, deposits of the clients or other form of coverage are normally used.

In the case of insolvency of the client/borrower, various accounting measures are adopted, with a partial devaluation of the credit in relation to various parameters, such as the value of the estate and sales price. The mortgage does not appear directly on the accounts as it is an off-balance guarantee and consequently it does not appear in the book-keeping accounts.

Table 3 shows the same accounting profile using the method and system described herein. As the HPV quotas owned by the bank are financial instruments, they can be inserted under the item “Investments” of the Assets, whereas in the Liabilities, they can have a coverage analogous to that of mortgages or be covered by long-term debt instruments and deposits.

TABLE 3
Quota based plan value $200,000
Bank balance sheet (value in $)

| | |
|---|---|
| Assets | Liabilities |

| | | | |
|---|---|---|---|
| Investments | 200,000 | Long-term debt, deposits | 200,000 |

In this system, as the bank is the owner of the quotas, having the HPV quotas in its possession as financial assets or investment securities. Therefore these quotas are financial activities, in which the guarantee is no longer the mortgage but the same HPV quotas possessed by the bank and not yet redeemed by the owner. It is therefore an actual guarantee, directly written in the financial statements, with no risk of insolvency of the client, as, in the case of non-payment on the part of the latter, there is no need to devaluate the credit but simply evict the subject in arrears and find a new buyer of the estate, in addition to the recovery of the non-paid installments from the quotas already possessed by the owner according to the present scheme. The guarantee therefore changes on a monthly basis and the financial statements consequently provide an updated reflection of the financial risks of the operation.

With this method, in fact, what was originally an accounting credit (with mortgages) and therefore a debt, with this system becomes a “Security”.

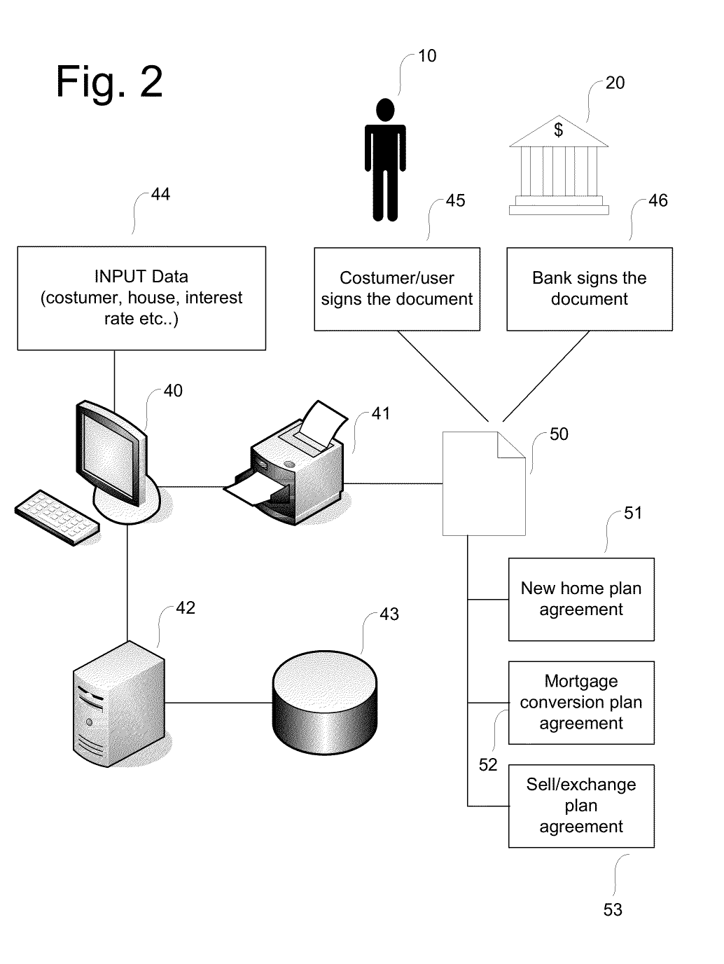

FIG. 2 illustrates the method and system described above, which requires a computerized system to be implemented—consisting of a data processing unit (40) and a printer (41)—which registers the input data (44):
data of the buyer
identification data of the estate
data of the legal entity in whose name the estate is registered
value of the estate
duration of the buying plan
number of quotas
number of quotas acquired by the buyer in the initial phase
insertion of additional costs such as the annual taxes on the estate (property tax), which, in this way, are transferred from the bank to the client, various insurances
administration running costs and annual taxations for maintaining the HPV.

Said processing unit (40), using the input data (44), prepares an acquisition plan of the quotas according to a French amortization plan based on (table 4)
amount to be financed
rate of interest to be applied
duration of time within which the quotas are repurchased
annual property taxations, divided into the number of monthly quotas for the reference year
running costs and maintenance taxations of the HPV, divided into the number of monthly installments for the reference year, including the insurance costs of the property against a series of risks as well as property taxes on the estate. For the sake of simplicity, Table 4 does not show these additional costs.

The document (50) is thus obtained, printed by means of a printer 41, signed (45) by the client (10) and also signed (46) by the bank (20). This document (50) is a contract which regulates the acquisition of a new estate (51) by means of an acquisition plan of quotas according to the present invention. Or it can be a contract for converting a traditional mortgage (52) into a reacquisition plan based on the present invention or a sales contract (53) or exchange of quotas included in the present invention.

The input data, the document and data developed by the processing unit (40) are stored in a central server (42) in the relative database system (43).

FIG. 3 shows a block diagram with the method which allows the calculation of the monthly payment and the value of the monthly installments with the relative balance of the same.

The value of the house (70) is inserted, together with the number of months (71) which indicates the duration of the reacquisition plan, obtaining the QuotaNum For the sake of convenience, this number can correspond to the number of quotas, which can be arbitrary, into which the HPV (30) is divided. In 72 the computer calculates the value of a single quota (QuotaValue), dividing the value of the house (House Value) by the number of quotas (QuotaNum) to be repurchased. The next step comprises the insertion of the value of the possible down-payment (73), whereas step 74 processes the value of the quotas acquired (Acquired QuotaNum) with the down-payment, dividing the down-payment by the unitary value of each quota (QuotaValue). In 75 the number of quotas to be financed (FinQuotaNum) is calculated, i.e. the number of quotas which are allowed to be gradually acquired according to the present invention, by subtracting the number of quotas acquired from the total number of quotas. In 76 the amount of the plan (RepurchasingPlan) of the financing, is calculated by multiplying the unitary value of the quotas (QuotaValue) by the number of quotas which will be financed (FinQuotaNum). Subsequently, in 77 the interest rate is provided, which can be fixed or is variable and in 78 the repayment plan is calculated, like that shown in table 4, which generates the amount of the monthly installment (79) and the value and balance of the quotas after the payment of each installment.

Table 4 represents the schedule of the French amortization plan indicated in table 3, the last three columns determine, for each month, the amount of the quota acquired, the total of the quotas owned by the bank and the number of quotas accumulated by the customer.

TABLE 4
Financing: $ 300,000 30 year fixed 6% interest rate
Quota value $ 1000

| | Principal | | Principal | Interest | | | Bank owned | Costumer |
|---|---|---|---|---|---|---|---|---|
| Payment # | Balance | Monthly Payment | Amount | Amount | Residual Balance | Quota acquired | quota | owned quota |
| | | | | | | | | 60 |
| 1 | 300,000.00 | 1,798.65 | 298.65 | 1,500.00 | 299,701.35 | 0.30 | 300.00 | 60.30 |
| 2 | 299,701.35 | 1,798.65 | 300.14 | 1,498.51 | 299,401.20 | 0.30 | 299.70 | 60.60 |
| 3 | 299,401.20 | 1,798.65 | 301.65 | 1,497.01 | 299,099.56 | 0.30 | 299.40 | 60.90 |
| 4 | 299,099.56 | 1,798.65 | 303.15 | 1,495.50 | 298,796.40 | 0.30 | 299.10 | 61.20 |
| 5 | 298,796.40 | 1,798.65 | 304.67 | 1,493.98 | 298,491.73 | 0.30 | 298.80 | 61.51 |
| 6 | 298,491.73 | 1,798.65 | 306.19 | 1,492.46 | 298,185.54 | 0.31 | 298.49 | 61.81 |
| 7 | 298,185.54 | 1,798.65 | 307.72 | 1,490.93 | 297,877.82 | 0.31 | 298.19 | 62.12 |
| 8 | 297,877.82 | 1,798.65 | 309.26 | 1,489.39 | 297,568.56 | 0.31 | 297.88 | 62.43 |
| 9 | 297,568.56 | 1,798.65 | 310.81 | 1,487.84 | 297,257.75 | 0.31 | 297.57 | 62.74 |
| 10 | 297,257.75 | 1,798.65 | 312.36 | 1,486.29 | 296,945.38 | 0.31 | 297.26 | 63.05 |
| 11 | 296,945.38 | 1,798.65 | 313.92 | 1,484.73 | 296,631.46 | 0.31 | 296.95 | 63.37 |
| 12 | 296,631.46 | 1,798.65 | 315.49 | 1,483.16 | 296,315.96 | 0.32 | 296.63 | 63.68 |
| 13 | 296,315.96 | 1,798.65 | 317.07 | 1,481.58 | 295,998.89 | 0.32 | 296.32 | 64.00 |
| 14 | 295,998.89 | 1,798.65 | 318.66 | 1,479.99 | 295,680.24 | 0.32 | 296.00 | 64.32 |
| 15 | 295,680.24 | 1,798.65 | 320.25 | 1,478.40 | 295,359.99 | 0.32 | 295.68 | 64.64 |
| 16 | 295,359.99 | 1,798.65 | 321.85 | 1,476.80 | 295,038.13 | 0.32 | 295.36 | 64.96 |
| 17 | 295,038.13 | 1,798.65 | 323.46 | 1,475.19 | 294,714.67 | 0.32 | 295.04 | 65.29 |
| 18 | 294,714.67 | 1,798.65 | 325.08 | 1,473.57 | 294,389.59 | 0.33 | 294.71 | 65.61 |
| 19 | 294,389.59 | 1,798.65 | 326.70 | 1,471.95 | 294,062.89 | 0.33 | 294.39 | 65.94 |
| 20 | 294,062.89 | 1,798.65 | 328.34 | 1,470.31 | 293,734.55 | 0.33 | 294.06 | 66.27 |
| 21 | 293,734.55 | 1,798.65 | 329.98 | 1,468.67 | 293,404.58 | 0.33 | 293.73 | 66.60 |
| 22 | 293,404.58 | 1,798.65 | 331.63 | 1,467.02 | 293,072.95 | 0.33 | 293.40 | 66.93 |
| 23 | 293,072.95 | 1,798.65 | 333.29 | 1,465.36 | 292,739.66 | 0.33 | 293.07 | 67.26 |
| 24 | 292,739.66 | 1,798.65 | 334.95 | 1,463.70 | 292,404.71 | 0.33 | 292.74 | 67.60 |
| 25 | 292,404.71 | 1,798.65 | 336.63 | 1,462.02 | 292,068.08 | 0.34 | 292.40 | 67.93 |
| 26 | 292,068.08 | 1,798.65 | 338.31 | 1,460.34 | 291,729.77 | 0.34 | 292.07 | 68.27 |
| 27 | 291,729.77 | 1,798.65 | 340.00 | 1,458.65 | 291,389.76 | 0.34 | 291.73 | 68.61 |
| 28 | 291,389.76 | 1,798.65 | 341.70 | 1,456.95 | 291,048.06 | 0.34 | 291.39 | 68.95 |
| 29 | 291,048.06 | 1,798.65 | 343.41 | 1,455.24 | 290,704.65 | 0.34 | 291.05 | 69.30 |
| 30 | 290,704.65 | 1,798.65 | 345.13 | 1,453.52 | 290,359.52 | 0.35 | 290.70 | 69.64 |
| 31 | 290,359.52 | 1,798.65 | 346.85 | 1,451.80 | 290,012.67 | 0.35 | 290.36 | 69.99 |
| 32 | 290,012.67 | 1,798.65 | 348.59 | 1,450.06 | 289,664.08 | 0.35 | 290.01 | 70.34 |
| 33 | 289,664.08 | 1,798.65 | 350.33 | 1,448.32 | 289,313.75 | 0.35 | 289.66 | 70.69 |
| 34 | 289,313.75 | 1,798.65 | 352.08 | 1,446.57 | 288,961.67 | 0.35 | 289.31 | 71.04 |
| 35 | 288,961.67 | 1,798.65 | 353.84 | 1,444.81 | 288,607.82 | 0.35 | 288.96 | 71.39 |
| 36 | 288,607.82 | 1,798.65 | 355.61 | 1,443.04 | 288,252.21 | 0.36 | 288.61 | 71.75 |
| 37 | 288,252.21 | 1,798.65 | 357.39 | 1,441.26 | 287,894.82 | 0.36 | 288.25 | 72.11 |
| 38 | 287,894.82 | 1,798.65 | 359.18 | 1,439.47 | 287,535.64 | 0.36 | 287.89 | 72.46 |
| 39 | 287,535.64 | 1,798.65 | 360.97 | 1,437.68 | 287,174.67 | 0.36 | 287.54 | 72.83 |
| 40 | 287,174.67 | 1,798.65 | 362.78 | 1,435.87 | 286,811.89 | 0.36 | 287.17 | 73.19 |
| 41 | 286,811.89 | 1,798.65 | 364.59 | 1,434.06 | 286,447.30 | 0.36 | 286.81 | 73.55 |
| 42 | 286,447.30 | 1,798.65 | 366.42 | 1,432.24 | 286,080.88 | 0.37 | 286.45 | 73.92 |
| 43 | 286,080.88 | 1,798.65 | 368.25 | 1,430.40 | 285,712.64 | 0.37 | 286.08 | 74.29 |
| 44 | 285,712.64 | 1,798.65 | 370.09 | 1,428.56 | 285,342.55 | 0.37 | 285.71 | 74.66 |
| 45 | 285,342.55 | 1,798.65 | 371.94 | 1,426.71 | 284,970.61 | 0.37 | 285.34 | 75.03 |
| 46 | 284,970.61 | 1,798.65 | 373.80 | 1,424.85 | 284,596.81 | 0.37 | 284.97 | 75.40 |
| 47 | 284,596.81 | 1,798.65 | 375.67 | 1,422.98 | 284,221.14 | 0.38 | 284.60 | 75.78 |
| 48 | 284,221.14 | 1,798.65 | 377.55 | 1,421.11 | 283,843.60 | 0.38 | 284.22 | 76.16 |
| 49 | 283,843.60 | 1,798.65 | 379.43 | 1,419.22 | 283,464.16 | 0.38 | 283.84 | 76.54 |
| 50 | 283,464.16 | 1,798.65 | 381.33 | 1,417.32 | 283,082.83 | 0.38 | 283.46 | 76.92 |
| 51 | 283,082.83 | 1,798.65 | 383.24 | 1,415.41 | 282,699.60 | 0.38 | 283.08 | 77.30 |
| 52 | 282,699.60 | 1,798.65 | 385.15 | 1,413.50 | 282,314.44 | 0.39 | 282.70 | 77.69 |
| 53 | 282,314.44 | 1,798.65 | 387.08 | 1,411.57 | 281,927.36 | 0.39 | 282.31 | 78.07 |
| 54 | 281,927.36 | 1,798.65 | 389.01 | 1,409.64 | 281,538.35 | 0.39 | 281.93 | 78.46 |
| 55 | 281,538.35 | 1,798.65 | 390.96 | 1,407.69 | 281,147.39 | 0.39 | 281.54 | 78.85 |
| 56 | 281,147.39 | 1,798.65 | 392.91 | 1,405.74 | 280,754.47 | 0.39 | 281.15 | 79.25 |
| 57 | 280,754.47 | 1,798.65 | 394.88 | 1,403.77 | 280,359.59 | 0.39 | 280.75 | 79.64 |
| 58 | 280,359.59 | 1,798.65 | 396.85 | 1,401.80 | 279,962.74 | 0.40 | 280.36 | 80.04 |
| 59 | 279,962.74 | 1,798.65 | 398.84 | 1,399.81 | 279,563.90 | 0.40 | 279.96 | 80.44 |
| 60 | 279,563.90 | 1,798.65 | 400.83 | 1,397.82 | 279,163.07 | 0.40 | 279.56 | 80.84 |
| 61 | 279,163.07 | 1,798.65 | 402.84 | 1,395.82 | 278,760.23 | 0.40 | 279.16 | 81.24 |
| 62 | 278,760.23 | 1,798.65 | 404.85 | 1,393.80 | 278,355.38 | 0.40 | 278.76 | 81.64 |
| 63 | 278,355.38 | 1,798.65 | 406.87 | 1,391.78 | 277,948.51 | 0.41 | 278.36 | 82.05 |
| 64 | 277,948.51 | 1,798.65 | 408.91 | 1,389.74 | 277,539.60 | 0.41 | 277.95 | 82.46 |
| 65 | 277,539.60 | 1,798.65 | 410.95 | 1,387.70 | 277,128.65 | 0.41 | 277.54 | 82.87 |
| 66 | 277,128.65 | 1,798.65 | 413.01 | 1,385.64 | 276,715.64 | 0.41 | 277.13 | 83.28 |
| 67 | 276,715.64 | 1,798.65 | 415.07 | 1,383.58 | 276,300.56 | 0.42 | 276.72 | 83.70 |
| 68 | 276,300.56 | 1,798.65 | 417.15 | 1,381.50 | 275,883.42 | 0.42 | 276.30 | 84.12 |
| 69 | 275,883.42 | 1,798.65 | 419.23 | 1,379.42 | 275,464.18 | 0.42 | 275.88 | 84.54 |
| 70 | 275,464.18 | 1,798.65 | 421.33 | 1,377.32 | 275,042.85 | 0.42 | 275.46 | 84.96 |
| 71 | 275,042.85 | 1,798.65 | 423.44 | 1,375.21 | 274,619.41 | 0.42 | 275.04 | 85.38 |
| 72 | 274,619.41 | 1,798.65 | 425.55 | 1,373.10 | 274,193.86 | 0.43 | 274.62 | 85.81 |
| 73 | 274,193.86 | 1,798.65 | 427.68 | 1,370.97 | 273,766.18 | 0.43 | 274.19 | 86.23 |
| 74 | 273,766.18 | 1,798.65 | 429.82 | 1,368.83 | 273,336.36 | 0.43 | 273.77 | 86.66 |
| 75 | 273,336.36 | 1,798.65 | 431.97 | 1,366.68 | 272,904.39 | 0.43 | 273.34 | 87.10 |
| 76 | 272,904.39 | 1,798.65 | 434.13 | 1,364.52 | 272,470.26 | 0.43 | 272.90 | 87.53 |
| 77 | 272,470.26 | 1,798.65 | 436.30 | 1,362.35 | 272,033.96 | 0.44 | 272.47 | 87.97 |
| 78 | 272,033.96 | 1,798.65 | 438.48 | 1,360.17 | 271,595.47 | 0.44 | 272.03 | 88.40 |
| 79 | 271,595.47 | 1,798.65 | 440.67 | 1,357.98 | 271,154.80 | 0.44 | 271.60 | 88.85 |
| 80 | 271,154.80 | 1,798.65 | 442.88 | 1,355.77 | 270,711.92 | 0.44 | 271.15 | 89.29 |
| 81 | 270,711.92 | 1,798.65 | 445.09 | 1,353.56 | 270,266.83 | 0.45 | 270.71 | 89.73 |
| 82 | 270,266.83 | 1,798.65 | 447.32 | 1,351.33 | 269,819.51 | 0.45 | 270.27 | 90.18 |
| 83 | 269,819.51 | 1,798.65 | 449.55 | 1,349.10 | 269,369.96 | 0.45 | 269.82 | 90.63 |
| 84 | 269,369.96 | 1,798.65 | 451.80 | 1,346.85 | 268,918.16 | 0.45 | 269.37 | 91.08 |
| 85 | 268,918.16 | 1,798.65 | 454.06 | 1,344.59 | 268,464.10 | 0.45 | 268.92 | 91.54 |
| 86 | 268,464.10 | 1,798.65 | 456.33 | 1,342.32 | 268,007.77 | 0.46 | 268.46 | 91.99 |
| 87 | 268,007.77 | 1,798.65 | 458.61 | 1,340.04 | 267,549.15 | 0.46 | 268.01 | 92.45 |
| 88 | 267,549.15 | 1,798.65 | 460.91 | 1,337.75 | 267,088.25 | 0.46 | 267.55 | 92.91 |
| 89 | 267,088.25 | 1,798.65 | 463.21 | 1,335.44 | 266,625.04 | 0.46 | 267.09 | 93.37 |
| 90 | 266,625.04 | 1,798.65 | 465.53 | 1,333.13 | 266,159.51 | 0.47 | 266.63 | 93.84 |
| 91 | 266,159.51 | 1,798.65 | 467.85 | 1,330.80 | 265,691.66 | 0.47 | 266.16 | 94.31 |
| 92 | 265,691.66 | 1,798.65 | 470.19 | 1,328.46 | 265,221.46 | 0.47 | 265.69 | 94.78 |
| 93 | 265,221.46 | 1,798.65 | 472.54 | 1,326.11 | 264,748.92 | 0.47 | 265.22 | 95.25 |
| 94 | 264,748.92 | 1,798.65 | 474.91 | 1,323.74 | 264,274.01 | 0.47 | 264.75 | 95.73 |
| 95 | 264,274.01 | 1,798.65 | 477.28 | 1,321.37 | 263,796.73 | 0.48 | 264.27 | 96.20 |
| 96 | 263,796.73 | 1,798.65 | 479.67 | 1,318.98 | 263,317.06 | 0.48 | 263.80 | 96.68 |
| 97 | 263,317.06 | 1,798.65 | 482.07 | 1,316.59 | 262,835.00 | 0.48 | 263.32 | 97.17 |
| 98 | 262,835.00 | 1,798.65 | 484.48 | 1,314.17 | 262,350.52 | 0.48 | 262.83 | 97.65 |
| 99 | 262,350.52 | 1,798.65 | 486.90 | 1,311.75 | 261,863.62 | 0.49 | 262.35 | 98.14 |
| 100 | 261,863.62 | 1,798.65 | 489.33 | 1,309.32 | 261,374.29 | 0.49 | 261.86 | 98.63 |
| 101 | 261,374.29 | 1,798.65 | 491.78 | 1,306.87 | 260,882.51 | 0.49 | 261.37 | 99.12 |
| 102 | 260,882.51 | 1,798.65 | 494.24 | 1,304.41 | 260,388.27 | 0.49 | 260.88 | 99.61 |
| 103 | 260,388.27 | 1,798.65 | 496.71 | 1,301.94 | 259,891.56 | 0.50 | 260.39 | 100.11 |
| 104 | 259,891.56 | 1,798.65 | 499.19 | 1,299.46 | 259,392.36 | 0.50 | 259.89 | 100.61 |
| 105 | 259,392.36 | 1,798.65 | 501.69 | 1,296.96 | 258,890.67 | 0.50 | 259.39 | 101.11 |
| 106 | 258,890.67 | 1,798.65 | 504.20 | 1,294.45 | 258,386.48 | 0.50 | 258.89 | 101.61 |
| 107 | 258,386.48 | 1,798.65 | 506.72 | 1,291.93 | 257,879.76 | 0.51 | 258.39 | 102.12 |
| 108 | 257,879.76 | 1,798.65 | 509.25 | 1,289.40 | 257,370.50 | 0.51 | 257.88 | 102.63 |
| 109 | 257,370.50 | 1,798.65 | 511.80 | 1,286.85 | 256,858.71 | 0.51 | 257.37 | 103.14 |
| 110 | 256,858.71 | 1,798.65 | 514.36 | 1,284.29 | 256,344.35 | 0.51 | 256.86 | 103.66 |
| 111 | 256,344.35 | 1,798.65 | 516.93 | 1,281.72 | 255,827.42 | 0.52 | 256.34 | 104.17 |
| 112 | 255,827.42 | 1,798.65 | 519.51 | 1,279.14 | 255,307.90 | 0.52 | 255.83 | 104.69 |
| 113 | 255,307.90 | 1,798.65 | 522.11 | 1,276.54 | 254,785.79 | 0.52 | 255.31 | 105.21 |
| 114 | 254,785.79 | 1,798.65 | 524.72 | 1,273.93 | 254,261.07 | 0.52 | 254.79 | 105.74 |
| 115 | 254,261.07 | 1,798.65 | 527.35 | 1,271.31 | 253,733.72 | 0.53 | 254.26 | 106.27 |
| 116 | 253,733.72 | 1,798.65 | 529.98 | 1,268.67 | 253,203.74 | 0.53 | 253.73 | 106.80 |
| 117 | 253,203.74 | 1,798.65 | 532.63 | 1,266.02 | 252,671.11 | 0.53 | 253.20 | 107.33 |
| 118 | 252,671.11 | 1,798.65 | 535.30 | 1,263.36 | 252,135.81 | 0.54 | 252.67 | 107.86 |
| 119 | 252,135.81 | 1,798.65 | 537.97 | 1,260.68 | 251,597.84 | 0.54 | 252.14 | 108.40 |
| 120 | 251,597.84 | 1,798.65 | 540.66 | 1,257.99 | 251,057.17 | 0.54 | 251.60 | 108.94 |
| 121 | 251,057.17 | 1,798.65 | 543.37 | 1,255.29 | 250,513.81 | 0.54 | 251.06 | 109.49 |
| 122 | 250,513.81 | 1,798.65 | 546.08 | 1,252.57 | 249,967.73 | 0.55 | 250.51 | 110.03 |
| 123 | 249,967.73 | 1,798.65 | 548.81 | 1,249.84 | 249,418.91 | 0.55 | 249.97 | 110.58 |
| 124 | 249,418.91 | 1,798.65 | 551.56 | 1,247.09 | 248,867.36 | 0.55 | 249.42 | 111.13 |
| 125 | 248,867.36 | 1,798.65 | 554.31 | 1,244.34 | 248,313.04 | 0.55 | 248.87 | 111.69 |
| 126 | 248,313.04 | 1,798.65 | 557.09 | 1,241.57 | 247,755.96 | 0.56 | 248.31 | 112.24 |
| 127 | 247,755.96 | 1,798.65 | 559.87 | 1,238.78 | 247,196.08 | 0.56 | 247.76 | 112.80 |
| 128 | 247,196.08 | 1,798.65 | 562.67 | 1,235.98 | 246,633.41 | 0.56 | 247.20 | 113.37 |
| 129 | 246,633.41 | 1,798.65 | 565.48 | 1,233.17 | 246,067.93 | 0.57 | 246.63 | 113.93 |
| 130 | 246,067.93 | 1,798.65 | 568.31 | 1,230.34 | 245,499.62 | 0.57 | 246.07 | 114.50 |
| 131 | 245,499.62 | 1,798.65 | 571.15 | 1,227.50 | 244,928.46 | 0.57 | 245.50 | 115.07 |
| 132 | 244,928.46 | 1,798.65 | 574.01 | 1,224.64 | 244,354.45 | 0.57 | 244.93 | 115.65 |
| 133 | 244,354.45 | 1,798.65 | 576.88 | 1,221.77 | 243,777.57 | 0.58 | 244.35 | 116.22 |
| 134 | 243,777.57 | 1,798.65 | 579.76 | 1,218.89 | 243,197.81 | 0.58 | 243.78 | 116.80 |
| 135 | 243,197.81 | 1,798.65 | 582.66 | 1,215.99 | 242,615.15 | 0.58 | 243.20 | 117.38 |
| 136 | 242,615.15 | 1,798.65 | 585.58 | 1,213.08 | 242,029.57 | 0.59 | 242.62 | 117.97 |
| 137 | 242,029.57 | 1,798.65 | 588.50 | 1,210.15 | 241,441.07 | 0.59 | 242.03 | 118.56 |
| 138 | 241,441.07 | 1,798.65 | 591.45 | 1,207.21 | 240,849.62 | 0.59 | 241.44 | 119.15 |
| 139 | 240,849.62 | 1,798.65 | 594.40 | 1,204.25 | 240,255.22 | 0.59 | 240.85 | 119.74 |
| 140 | 240,255.22 | 1,798.65 | 597.38 | 1,201.28 | 239,657.84 | 0.60 | 240.26 | 120.34 |
| 141 | 239,657.84 | 1,798.65 | 600.36 | 1,198.29 | 239,057.48 | 0.60 | 239.66 | 120.94 |
| 142 | 239,057.48 | 1,798.65 | 603.36 | 1,195.29 | 238,454.12 | 0.60 | 239.06 | 121.55 |
| 143 | 238,454.12 | 1,798.65 | 606.38 | 1,192.27 | 237,847.74 | 0.61 | 238.45 | 122.15 |
| 144 | 237,847.74 | 1,798.65 | 609.41 | 1,189.24 | 237,238.32 | 0.61 | 237.85 | 122.76 |
| 145 | 237,238.32 | 1,798.65 | 612.46 | 1,186.19 | 236,625.86 | 0.61 | 237.24 | 123.37 |
| 146 | 236,625.86 | 1,798.65 | 615.52 | 1,183.13 | 236,010.34 | 0.62 | 236.63 | 123.99 |
| 147 | 236,010.34 | 1,798.65 | 618.60 | 1,180.05 | 235,391.74 | 0.62 | 236.01 | 124.61 |
| 148 | 235,391.74 | 1,798.65 | 621.69 | 1,176.96 | 234,770.05 | 0.62 | 235.39 | 125.23 |
| 149 | 234,770.05 | 1,798.65 | 624.80 | 1,173.85 | 234,145.25 | 0.62 | 234.77 | 125.85 |
| 150 | 234,145.25 | 1,798.65 | 627.93 | 1,170.73 | 233,517.32 | 0.63 | 234.15 | 126.48 |
| 151 | 233,517.32 | 1,798.65 | 631.06 | 1,167.59 | 232,886.26 | 0.63 | 233.52 | 127.11 |
| 152 | 232,886.26 | 1,798.65 | 634.22 | 1,164.43 | 232,252.04 | 0.63 | 232.89 | 127.75 |
| 153 | 232,252.04 | 1,798.65 | 637.39 | 1,161.26 | 231,614.64 | 0.64 | 232.25 | 128.39 |
| 154 | 231,614.64 | 1,798.65 | 640.58 | 1,158.07 | 230,974.07 | 0.64 | 231.61 | 129.03 |
| 155 | 230,974.07 | 1,798.65 | 643.78 | 1,154.87 | 230,330.28 | 0.64 | 230.97 | 129.67 |
| 156 | 230,330.28 | 1,798.65 | 647.00 | 1,151.65 | 229,683.28 | 0.65 | 230.33 | 130.32 |
| 157 | 229,683.28 | 1,798.65 | 650.24 | 1,148.42 | 229,033.05 | 0.65 | 229.68 | 130.97 |
| 158 | 229,033.05 | 1,798.65 | 653.49 | 1,145.17 | 228,379.56 | 0.65 | 229.03 | 131.62 |
| 159 | 228,379.56 | 1,798.65 | 656.75 | 1,141.90 | 227,722.81 | 0.66 | 228.38 | 132.28 |
| 160 | 227,722.81 | 1,798.65 | 660.04 | 1,138.61 | 227,062.77 | 0.66 | 227.72 | 132.94 |
| 161 | 227,062.77 | 1,798.65 | 663.34 | 1,135.31 | 226,399.43 | 0.66 | 227.06 | 133.60 |
| 162 | 226,399.43 | 1,798.65 | 666.65 | 1,132.00 | 225,732.78 | 0.67 | 226.40 | 134.27 |
| 163 | 225,732.78 | 1,798.65 | 669.99 | 1,128.66 | 225,062.79 | 0.67 | 225.73 | 134.94 |
| 164 | 225,062.79 | 1,798.65 | 673.34 | 1,125.31 | 224,389.45 | 0.67 | 225.06 | 135.61 |
| 165 | 224,389.45 | 1,798.65 | 676.70 | 1,121.95 | 223,712.75 | 0.68 | 224.39 | 136.29 |
| 166 | 223,712.75 | 1,798.65 | 680.09 | 1,118.56 | 223,032.66 | 0.68 | 223.71 | 136.97 |
| 167 | 223,032.66 | 1,798.65 | 683.49 | 1,115.16 | 222,349.17 | 0.68 | 223.03 | 137.65 |
| 168 | 222,349.17 | 1,798.65 | 686.91 | 1,111.75 | 221,662.27 | 0.69 | 222.35 | 138.34 |
| 169 | 221,662.27 | 1,798.65 | 690.34 | 1,108.31 | 220,971.93 | 0.69 | 221.66 | 139.03 |
| 170 | 220,971.93 | 1,798.65 | 693.79 | 1,104.86 | 220,278.14 | 0.69 | 220.97 | 139.72 |
| 171 | 220,278.14 | 1,798.65 | 697.26 | 1,101.39 | 219,580.88 | 0.70 | 220.28 | 140.42 |
| 172 | 219,580.88 | 1,798.65 | 700.75 | 1,097.90 | 218,880.13 | 0.70 | 219.58 | 141.12 |
| 173 | 218,880.13 | 1,798.65 | 704.25 | 1,094.40 | 218,175.88 | 0.70 | 218.88 | 141.82 |
| 174 | 218,175.88 | 1,798.65 | 707.77 | 1,090.88 | 217,468.10 | 0.71 | 218.18 | 142.53 |
| 175 | 217,468.10 | 1,798.65 | 711.31 | 1,087.34 | 216,756.79 | 0.71 | 217.47 | 143.24 |
| 176 | 216,756.79 | 1,798.65 | 714.87 | 1,083.78 | 216,041.93 | 0.71 | 216.76 | 143.96 |
| 177 | 216,041.93 | 1,798.65 | 718.44 | 1,080.21 | 215,323.48 | 0.72 | 216.04 | 144.68 |
| 178 | 215,323.48 | 1,798.65 | 722.03 | 1,076.62 | 214,601.45 | 0.72 | 215.32 | 145.40 |
| 179 | 214,601.45 | 1,798.65 | 725.64 | 1,073.01 | 213,875.81 | 0.73 | 214.60 | 146.12 |
| 180 | 213,875.81 | 1,798.65 | 729.27 | 1,069.38 | 213,146.53 | 0.73 | 213.88 | 146.85 |
| 181 | 213,146.53 | 1,798.65 | 732.92 | 1,065.73 | 212,413.61 | 0.73 | 213.15 | 147.59 |
| 182 | 212,413.61 | 1,798.65 | 736.58 | 1,062.07 | 211,677.03 | 0.74 | 212.41 | 148.32 |
| 183 | 211,677.03 | 1,798.65 | 740.27 | 1,058.39 | 210,936.76 | 0.74 | 211.68 | 149.06 |
| 184 | 210,936.76 | 1,798.65 | 743.97 | 1,054.68 | 210,192.80 | 0.74 | 210.94 | 149.81 |
| 185 | 210,192.80 | 1,798.65 | 747.69 | 1,050.96 | 209,445.11 | 0.75 | 210.19 | 150.55 |
| 186 | 209,445.11 | 1,798.65 | 751.43 | 1,047.23 | 208,693.68 | 0.75 | 209.45 | 151.31 |
| 187 | 208,693.68 | 1,798.65 | 755.18 | 1,043.47 | 207,938.50 | 0.76 | 208.69 | 152.06 |
| 188 | 207,938.50 | 1,798.65 | 758.96 | 1,039.69 | 207,179.54 | 0.76 | 207.94 | 152.82 |
| 189 | 207,179.54 | 1,798.65 | 762.75 | 1,035.90 | 206,416.79 | 0.76 | 207.18 | 153.58 |
| 190 | 206,416.79 | 1,798.65 | 766.57 | 1,032.08 | 205,650.22 | 0.77 | 206.42 | 154.35 |
| 191 | 205,650.22 | 1,798.65 | 770.40 | 1,028.25 | 204,879.82 | 0.77 | 205.65 | 155.12 |
| 192 | 204,879.82 | 1,798.65 | 774.25 | 1,024.40 | 204,105.57 | 0.77 | 204.88 | 155.89 |
| 193 | 204,105.57 | 1,798.65 | 778.12 | 1,020.53 | 203,327.44 | 0.78 | 204.11 | 156.67 |
| 194 | 203,327.44 | 1,798.65 | 782.01 | 1,016.64 | 202,545.43 | 0.78 | 203.33 | 157.45 |
| 195 | 202,545.43 | 1,798.65 | 785.92 | 1,012.73 | 201,759.50 | 0.79 | 202.55 | 158.24 |
| 196 | 201,759.50 | 1,798.65 | 789.85 | 1,008.80 | 200,969.65 | 0.79 | 201.76 | 159.03 |
| 197 | 200,969.65 | 1,798.65 | 793.80 | 1,004.85 | 200,175.85 | 0.79 | 200.97 | 159.82 |
| 198 | 200,175.85 | 1,798.65 | 797.77 | 1,000.88 | 199,378.07 | 0.80 | 200.18 | 160.62 |
| 199 | 199,378.07 | 1,798.65 | 801.76 | 996.89 | 198,576.31 | 0.80 | 199.38 | 161.42 |
| 200 | 198,576.31 | 1,798.65 | 805.77 | 992.88 | 197,770.54 | 0.81 | 198.58 | 162.23 |
| 201 | 197,770.54 | 1,798.65 | 809.80 | 988.85 | 196,960.74 | 0.81 | 197.77 | 163.04 |
| 202 | 196,960.74 | 1,798.65 | 813.85 | 984.80 | 196,146.90 | 0.81 | 196.96 | 163.85 |
| 203 | 196,146.90 | 1,798.65 | 817.92 | 980.73 | 195,328.98 | 0.82 | 196.15 | 164.67 |
| 204 | 195,328.98 | 1,798.65 | 822.01 | 976.64 | 194,506.97 | 0.82 | 195.33 | 165.49 |
| 205 | 194,506.97 | 1,798.65 | 826.12 | 972.53 | 193,680.86 | 0.83 | 194.51 | 166.32 |
| 206 | 193,680.86 | 1,798.65 | 830.25 | 968.40 | 192,850.61 | 0.83 | 193.68 | 167.15 |
| 207 | 192,850.61 | 1,798.65 | 834.40 | 964.25 | 192,016.21 | 0.83 | 192.85 | 167.98 |
| 208 | 192,016.21 | 1,798.65 | 838.57 | 960.08 | 191,177.64 | 0.84 | 192.02 | 168.82 |
| 209 | 191,177.64 | 1,798.65 | 842.76 | 955.89 | 190,334.88 | 0.84 | 191.18 | 169.67 |
| 210 | 190,334.88 | 1,798.65 | 846.98 | 951.67 | 189,487.90 | 0.85 | 190.33 | 170.51 |
| 211 | 189,487.90 | 1,798.65 | 851.21 | 947.44 | 188,636.69 | 0.85 | 189.49 | 171.36 |
| 212 | 188,636.69 | 1,798.65 | 855.47 | 943.18 | 187,781.22 | 0.86 | 188.64 | 172.22 |
| 213 | 187,781.22 | 1,798.65 | 859.75 | 938.91 | 186,921.47 | 0.86 | 187.78 | 173.08 |
| 214 | 186,921.47 | 1,798.65 | 864.04 | 934.61 | 186,057.43 | 0.86 | 186.92 | 173.94 |
| 215 | 186,057.43 | 1,798.65 | 868.36 | 930.29 | 185,189.06 | 0.87 | 186.06 | 174.81 |
| 216 | 185,189.06 | 1,798.65 | 872.71 | 925.95 | 184,316.36 | 0.87 | 185.19 | 175.68 |
| 217 | 184,316.36 | 1,798.65 | 877.07 | 921.58 | 183,439.29 | 0.88 | 184.32 | 176.56 |
| 218 | 183,439.29 | 1,798.65 | 881.46 | 917.20 | 182,557.83 | 0.88 | 183.44 | 177.44 |
| 219 | 182,557.83 | 1,798.65 | 885.86 | 912.79 | 181,671.97 | 0.89 | 182.56 | 178.33 |
| 220 | 181,671.97 | 1,798.65 | 890.29 | 908.36 | 180,781.68 | 0.89 | 181.67 | 179.22 |
| 221 | 180,781.68 | 1,798.65 | 894.74 | 903.91 | 179,886.94 | 0.89 | 180.78 | 180.11 |
| 222 | 179,886.94 | 1,798.65 | 899.22 | 899.43 | 178,987.72 | 0.90 | 179.89 | 181.01 |
| 223 | 178,987.72 | 1,798.65 | 903.71 | 894.94 | 178,084.01 | 0.90 | 178.99 | 181.92 |
| 224 | 178,084.01 | 1,798.65 | 908.23 | 890.42 | 177,175.77 | 0.91 | 178.08 | 182.82 |
| 225 | 177,175.77 | 1,798.65 | 912.77 | 885.88 | 176,263.00 | 0.91 | 177.18 | 183.74 |
| 226 | 176,263.00 | 1,798.65 | 917.34 | 881.32 | 175,345.67 | 0.92 | 176.26 | 184.65 |
| 227 | 175,345.67 | 1,798.65 | 921.92 | 876.73 | 174,423.74 | 0.92 | 175.35 | 185.58 |
| 228 | 174,423.74 | 1,798.65 | 926.53 | 872.12 | 173,497.21 | 0.93 | 174.42 | 186.50 |
| 229 | 173,497.21 | 1,798.65 | 931.17 | 867.49 | 172,566.04 | 0.93 | 173.50 | 187.43 |
| 230 | 172,566.04 | 1,798.65 | 935.82 | 862.83 | 171,630.22 | 0.94 | 172.57 | 188.37 |
| 231 | 171,630.22 | 1,798.65 | 940.50 | 858.15 | 170,689.72 | 0.94 | 171.63 | 189.31 |
| 232 | 170,689.72 | 1,798.65 | 945.20 | 853.45 | 169,744.52 | 0.95 | 170.69 | 190.26 |
| 233 | 169,744.52 | 1,798.65 | 949.93 | 848.72 | 168,794.59 | 0.95 | 169.74 | 191.21 |
| 234 | 168,794.59 | 1,798.65 | 954.68 | 843.97 | 167,839.91 | 0.95 | 168.79 | 192.16 |
| 235 | 167,839.91 | 1,798.65 | 959.45 | 839.20 | 166,880.46 | 0.96 | 167.84 | 193.12 |
| 236 | 166,880.46 | 1,798.65 | 964.25 | 834.40 | 165,916.21 | 0.96 | 166.88 | 194.08 |
| 237 | 165,916.21 | 1,798.65 | 969.07 | 829.58 | 164,947.14 | 0.97 | 165.92 | 195.05 |
| 238 | 164,947.14 | 1,798.65 | 973.92 | 824.74 | 163,973.22 | 0.97 | 164.95 | 196.03 |
| 239 | 163,973.22 | 1,798.65 | 978.79 | 819.87 | 162,994.44 | 0.98 | 163.97 | 197.01 |
| 240 | 162,994.44 | 1,798.65 | 983.68 | 814.97 | 162,010.76 | 0.98 | 162.99 | 197.99 |
| 241 | 162,010.76 | 1,798.65 | 988.60 | 810.05 | 161,022.16 | 0.99 | 162.01 | 198.98 |
| 242 | 161,022.16 | 1,798.65 | 993.54 | 805.11 | 160,028.62 | 0.99 | 161.02 | 199.97 |
| 243 | 160,028.62 | 1,798.65 | 998.51 | 800.14 | 159,030.11 | 1.00 | 160.03 | 200.97 |
| 244 | 159,030.11 | 1,798.65 | 1,003.50 | 795.15 | 158,026.61 | 1.00 | 159.03 | 201.97 |
| 245 | 158,026.61 | 1,798.65 | 1,008.52 | 790.13 | 157,018.09 | 1.01 | 158.03 | 202.98 |
| 246 | 157,018.09 | 1,798.65 | 1,013.56 | 785.09 | 156,004.53 | 1.01 | 157.02 | 204.00 |
| 247 | 156,004.53 | 1,798.65 | 1,018.63 | 780.02 | 154,985.90 | 1.02 | 156.00 | 205.01 |
| 248 | 154,985.90 | 1,798.65 | 1,023.72 | 774.93 | 153,962.18 | 1.02 | 154.99 | 206.04 |
| 249 | 153,962.18 | 1,798.65 | 1,028.84 | 769.81 | 152,933.34 | 1.03 | 153.96 | 207.07 |
| 250 | 152,933.34 | 1,798.65 | 1,033.98 | 764.67 | 151,899.35 | 1.03 | 152.93 | 208.10 |
| 251 | 151,899.35 | 1,798.65 | 1,039.15 | 759.50 | 150,860.20 | 1.04 | 151.90 | 209.14 |
| 252 | 150,860.20 | 1,798.65 | 1,044.35 | 754.30 | 149,815.85 | 1.04 | 150.86 | 210.18 |
| 253 | 149,815.85 | 1,798.65 | 1,049.57 | 749.08 | 148,766.28 | 1.05 | 149.82 | 211.23 |
| 254 | 148,766.28 | 1,798.65 | 1,054.82 | 743.83 | 147,711.46 | 1.05 | 148.77 | 212.29 |
| 255 | 147,711.46 | 1,798.65 | 1,060.09 | 738.56 | 146,651.36 | 1.06 | 147.71 | 213.35 |
| 256 | 146,651.36 | 1,798.65 | 1,065.39 | 733.26 | 145,585.97 | 1.07 | 146.65 | 214.41 |
| 257 | 145,585.97 | 1,798.65 | 1,070.72 | 727.93 | 144,515.25 | 1.07 | 145.59 | 215.48 |
| 258 | 144,515.25 | 1,798.65 | 1,076.08 | 722.58 | 143,439.17 | 1.08 | 144.52 | 216.56 |
| 259 | 143,439.17 | 1,798.65 | 1,081.46 | 717.20 | 142,357.71 | 1.08 | 143.44 | 217.64 |
| 260 | 142,357.71 | 1,798.65 | 1,086.86 | 711.79 | 141,270.85 | 1.09 | 142.36 | 218.73 |
| 261 | 141,270.85 | 1,798.65 | 1,092.30 | 706.35 | 140,178.55 | 1.09 | 141.27 | 219.82 |
| 262 | 140,178.55 | 1,798.65 | 1,097.76 | 700.89 | 139,080.80 | 1.10 | 140.18 | 220.92 |
| 263 | 139,080.80 | 1,798.65 | 1,103.25 | 695.40 | 137,977.55 | 1.10 | 139.08 | 222.02 |
| 264 | 137,977.55 | 1,798.65 | 1,108.76 | 689.89 | 136,868.78 | 1.11 | 137.98 | 223.13 |
| 265 | 136,868.78 | 1,798.65 | 1,114.31 | 684.34 | 135,754.48 | 1.11 | 136.87 | 224.25 |
| 266 | 135,754.48 | 1,798.65 | 1,119.88 | 678.77 | 134,634.60 | 1.12 | 135.75 | 225.37 |
| 267 | 134,634.60 | 1,798.65 | 1,125.48 | 673.17 | 133,509.12 | 1.13 | 134.63 | 226.49 |
| 268 | 133,509.12 | 1,798.65 | 1,131.11 | 667.55 | 132,378.01 | 1.13 | 133.51 | 227.62 |
| 269 | 132,378.01 | 1,798.65 | 1,136.76 | 661.89 | 131,241.25 | 1.14 | 132.38 | 228.76 |
| 270 | 131,241.25 | 1,798.65 | 1,142.45 | 656.21 | 130,098.81 | 1.14 | 131.24 | 229.90 |
| 271 | 130,098.81 | 1,798.65 | 1,148.16 | 650.49 | 128,950.65 | 1.15 | 130.10 | 231.05 |
| 272 | 128,950.65 | 1,798.65 | 1,153.90 | 644.75 | 127,796.75 | 1.15 | 128.95 | 232.20 |
| 273 | 127,796.75 | 1,798.65 | 1,159.67 | 638.98 | 126,637.08 | 1.16 | 127.80 | 233.36 |
| 274 | 126,637.08 | 1,798.65 | 1,165.47 | 633.19 | 125,471.62 | 1.17 | 126.64 | 234.53 |
| 275 | 125,471.62 | 1,798.65 | 1,171.29 | 627.36 | 124,300.32 | 1.17 | 125.47 | 235.70 |
| 276 | 124,300.32 | 1,798.65 | 1,177.15 | 621.50 | 123,123.17 | 1.18 | 124.30 | 236.88 |
| 277 | 123,123.17 | 1,798.65 | 1,183.04 | 615.62 | 121,940.14 | 1.18 | 123.12 | 238.06 |
| 278 | 121,940.14 | 1,798.65 | 1,188.95 | 609.70 | 120,751.19 | 1.19 | 121.94 | 239.25 |
| 279 | 120,751.19 | 1,798.65 | 1,194.90 | 603.76 | 119,556.29 | 1.19 | 120.75 | 240.44 |
| 280 | 119,556.29 | 1,798.65 | 1,200.87 | 597.78 | 118,355.42 | 1.20 | 119.56 | 241.64 |
| 281 | 118,355.42 | 1,798.65 | 1,206.87 | 591.78 | 117,148.55 | 1.21 | 118.36 | 242.85 |
| 282 | 117,148.55 | 1,798.65 | 1,212.91 | 585.74 | 115,935.64 | 1.21 | 117.15 | 244.06 |
| 283 | 115,935.64 | 1,798.65 | 1,218.97 | 579.68 | 114,716.66 | 1.22 | 115.94 | 245.28 |
| 284 | 114,716.66 | 1,798.65 | 1,225.07 | 573.58 | 113,491.60 | 1.23 | 114.72 | 246.51 |
| 285 | 113,491.60 | 1,798.65 | 1,231.19 | 567.46 | 112,260.40 | 1.23 | 113.49 | 247.74 |
| 286 | 112,260.40 | 1,798.65 | 1,237.35 | 561.30 | 111,023.05 | 1.24 | 112.26 | 248.98 |
| 287 | 111,023.05 | 1,798.65 | 1,243.54 | 555.12 | 109,779.52 | 1.24 | 111.02 | 250.22 |
| 288 | 109,779.52 | 1,798.65 | 1,249.75 | 548.90 | 108,529.76 | 1.25 | 109.78 | 251.47 |
| 289 | 108,529.76 | 1,798.65 | 1,256.00 | 542.65 | 107,273.76 | 1.26 | 108.53 | 252.73 |
| 290 | 107,273.76 | 1,798.65 | 1,262.28 | 536.37 | 106,011.48 | 1.26 | 107.27 | 253.99 |
| 291 | 106,011.48 | 1,798.65 | 1,268.59 | 530.06 | 104,742.88 | 1.27 | 106.01 | 255.26 |
| 292 | 104,742.88 | 1,798.65 | 1,274.94 | 523.71 | 103,467.94 | 1.27 | 104.74 | 256.53 |
| 293 | 103,467.94 | 1,798.65 | 1,281.31 | 517.34 | 102,186.63 | 1.28 | 103.47 | 257.81 |
| 294 | 102,186.63 | 1,798.65 | 1,287.72 | 510.93 | 100,898.91 | 1.29 | 102.19 | 259.10 |
| 295 | 100,898.91 | 1,798.65 | 1,294.16 | 504.49 | 99,604.76 | 1.29 | 100.90 | 260.40 |
| 296 | 99,604.76 | 1,798.65 | 1,300.63 | 498.02 | 98,304.13 | 1.30 | 99.60 | 261.70 |
| 297 | 98,304.13 | 1,798.65 | 1,307.13 | 491.52 | 96,997.00 | 1.31 | 98.30 | 263.00 |
| 298 | 96,997.00 | 1,798.65 | 1,313.67 | 484.98 | 95,683.33 | 1.31 | 97.00 | 264.32 |
| 299 | 95,683.33 | 1,798.65 | 1,320.23 | 478.42 | 94,363.10 | 1.32 | 95.68 | 265.64 |
| 300 | 94,363.10 | 1,798.65 | 1,326.84 | 471.82 | 93,036.26 | 1.33 | 94.36 | 266.96 |
| 301 | 93,036.26 | 1,798.65 | 1,333.47 | 465.18 | 91,702.79 | 1.33 | 93.04 | 268.30 |
| 302 | 91,702.79 | 1,798.65 | 1,340.14 | 458.51 | 90,362.65 | 1.34 | 91.70 | 269.64 |
| 303 | 90,362.65 | 1,798.65 | 1,346.84 | 451.81 | 89,015.82 | 1.35 | 90.36 | 270.98 |
| 304 | 89,015.82 | 1,798.65 | 1,353.57 | 445.08 | 87,662.24 | 1.35 | 89.02 | 272.34 |
| 305 | 87,662.24 | 1,798.65 | 1,360.34 | 438.31 | 86,301.90 | 1.36 | 87.66 | 273.70 |
| 306 | 86,301.90 | 1,798.65 | 1,367.14 | 431.51 | 84,934.76 | 1.37 | 86.30 | 275.07 |
| 307 | 84,934.76 | 1,798.65 | 1,373.98 | 424.67 | 83,560.78 | 1.37 | 84.93 | 276.44 |
| 308 | 83,560.78 | 1,798.65 | 1,380.85 | 417.80 | 82,179.93 | 1.38 | 83.56 | 277.82 |
| 309 | 82,179.93 | 1,798.65 | 1,387.75 | 410.90 | 80,792.18 | 1.39 | 82.18 | 279.21 |
| 310 | 80,792.18 | 1,798.65 | 1,394.69 | 403.96 | 79,397.49 | 1.39 | 80.79 | 280.60 |
| 311 | 79,397.49 | 1,798.65 | 1,401.66 | 396.99 | 77,995.83 | 1.40 | 79.40 | 282.00 |
| 312 | 77,995.83 | 1,798.65 | 1,408.67 | 389.98 | 76,587.16 | 1.41 | 78.00 | 283.41 |
| 313 | 76,587.16 | 1,798.65 | 1,415.72 | 382.94 | 75,171.44 | 1.42 | 76.59 | 284.83 |
| 314 | 75,171.44 | 1,798.65 | 1,422.79 | 375.86 | 73,748.65 | 1.42 | 75.17 | 286.25 |
| 315 | 73,748.65 | 1,798.65 | 1,429.91 | 368.74 | 72,318.74 | 1.43 | 73.75 | 287.68 |
| 316 | 72,318.74 | 1,798.65 | 1,437.06 | 361.59 | 70,881.68 | 1.44 | 72.32 | 289.12 |
| 317 | 70,881.68 | 1,798.65 | 1,444.24 | 354.41 | 69,437.44 | 1.44 | 70.88 | 290.56 |
| 318 | 69,437.44 | 1,798.65 | 1,451.46 | 347.19 | 67,985.97 | 1.45 | 69.44 | 292.01 |
| 319 | 67,985.97 | 1,798.65 | 1,458.72 | 339.93 | 66,527.25 | 1.46 | 67.99 | 293.47 |
| 320 | 66,527.25 | 1,798.65 | 1,466.02 | 332.64 | 65,061.23 | 1.47 | 66.53 | 294.94 |
| 321 | 65,061.23 | 1,798.65 | 1,473.35 | 325.31 | 63,587.89 | 1.47 | 65.06 | 296.41 |
| 322 | 63,587.89 | 1,798.65 | 1,480.71 | 317.94 | 62,107.18 | 1.48 | 63.59 | 297.89 |
| 323 | 62,107.18 | 1,798.65 | 1,488.12 | 310.54 | 60,619.06 | 1.49 | 62.11 | 299.38 |
| 324 | 60,619.06 | 1,798.65 | 1,495.56 | 303.10 | 59,123.51 | 1.50 | 60.62 | 300.88 |
| 325 | 59,123.51 | 1,798.65 | 1,503.03 | 295.62 | 57,620.47 | 1.50 | 59.12 | 302.38 |
| 326 | 57,620.47 | 1,798.65 | 1,510.55 | 288.10 | 56,109.92 | 1.51 | 57.62 | 303.89 |
| 327 | 56,109.92 | 1,798.65 | 1,518.10 | 280.55 | 54,591.82 | 1.52 | 56.11 | 305.41 |
| 328 | 54,591.82 | 1,798.65 | 1,525.69 | 272.96 | 53,066.13 | 1.53 | 54.59 | 306.93 |
| 329 | 53,066.13 | 1,798.65 | 1,533.32 | 265.33 | 51,532.81 | 1.53 | 53.07 | 308.47 |
| 330 | 51,532.81 | 1,798.65 | 1,540.99 | 257.66 | 49,991.82 | 1.54 | 51.53 | 310.01 |
| 331 | 49,991.82 | 1,798.65 | 1,548.69 | 249.96 | 48,443.13 | 1.55 | 49.99 | 311.56 |
| 332 | 48,443.13 | 1,798.65 | 1,556.44 | 242.22 | 46,886.69 | 1.56 | 48.44 | 313.11 |
| 333 | 46,886.69 | 1,798.65 | 1,564.22 | 234.43 | 45,322.47 | 1.56 | 46.89 | 314.68 |
| 334 | 45,322.47 | 1,798.65 | 1,572.04 | 226.61 | 43,750.43 | 1.57 | 45.32 | 316.25 |
| 335 | 43,750.43 | 1,798.65 | 1,579.90 | 218.75 | 42,170.53 | 1.58 | 43.75 | 317.83 |
| 336 | 42,170.53 | 1,798.65 | 1,587.80 | 210.85 | 40,582.73 | 1.59 | 42.17 | 319.42 |
| 337 | 40,582.73 | 1,798.65 | 1,595.74 | 202.91 | 38,987.00 | 1.60 | 40.58 | 321.01 |
| 338 | 38,987.00 | 1,798.65 | 1,603.72 | 194.93 | 37,383.28 | 1.60 | 38.99 | 322.62 |
| 339 | 37,383.28 | 1,798.65 | 1,611.74 | 186.92 | 35,771.55 | 1.61 | 37.38 | 324.23 |
| 340 | 35,771.55 | 1,798.65 | 1,619.79 | 178.86 | 34,151.75 | 1.62 | 35.77 | 325.85 |
| 341 | 34,151.75 | 1,798.65 | 1,627.89 | 170.76 | 32,523.86 | 1.63 | 34.15 | 327.48 |
| 342 | 32,523.86 | 1,798.65 | 1,636.03 | 162.62 | 30,887.83 | 1.64 | 32.52 | 329.11 |
| 343 | 30,887.83 | 1,798.65 | 1,644.21 | 154.44 | 29,243.61 | 1.64 | 30.89 | 330.76 |
| 344 | 29,243.61 | 1,798.65 | 1,652.43 | 146.22 | 27,591.18 | 1.65 | 29.24 | 332.41 |
| 345 | 27,591.18 | 1,798.65 | 1,660.70 | 137.96 | 25,930.48 | 1.66 | 27.59 | 334.07 |
| 346 | 25,930.48 | 1,798.65 | 1,669.00 | 129.65 | 24,261.49 | 1.67 | 25.93 | 335.74 |
| 347 | 24,261.49 | 1,798.65 | 1,677.34 | 121.31 | 22,584.14 | 1.68 | 24.26 | 337.42 |
| 348 | 22,584.14 | 1,798.65 | 1,685.73 | 112.92 | 20,898.41 | 1.69 | 22.58 | 339.10 |
| 349 | 20,898.41 | 1,798.65 | 1,694.16 | 104.49 | 19,204.25 | 1.69 | 20.90 | 340.80 |
| 350 | 19,204.25 | 1,798.65 | 1,702.63 | 96.02 | 17,501.62 | 1.70 | 19.20 | 342.50 |
| 351 | 17,501.62 | 1,798.65 | 1,711.14 | 87.51 | 15,790.48 | 1.71 | 17.50 | 344.21 |
| 352 | 15,790.48 | 1,798.65 | 1,719.70 | 78.95 | 14,070.78 | 1.72 | 15.79 | 345.93 |
| 353 | 14,070.78 | 1,798.65 | 1,728.30 | 70.35 | 12,342.48 | 1.73 | 14.07 | 347.66 |
| 354 | 12,342.48 | 1,798.65 | 1,736.94 | 61.71 | 10,605.54 | 1.74 | 12.34 | 349.39 |
| 355 | 10,605.54 | 1,798.65 | 1,745.62 | 53.03 | 8,859.92 | 1.75 | 10.61 | 351.14 |
| 356 | 8,859.92 | 1,798.65 | 1,754.35 | 44.30 | 7,105.57 | 1.75 | 8.86 | 352.89 |
| 357 | 7,105.57 | 1,798.65 | 1,763.12 | 35.53 | 5,342.44 | 1.76 | 7.11 | 354.66 |
| 358 | 5,342.44 | 1,798.65 | 1,771.94 | 26.71 | 3,570.50 | 1.77 | 5.34 | 356.43 |
| 359 | 3,570.50 | 1,798.65 | 1,780.80 | 17.85 | 1,789.70 | 1.78 | 3.57 | 358.21 |
| 360 | 1,789.70 | 1,798.65 | 1,780.75 | 8.95 | 0.00 | 1.78 | 1.79 | 359.99 |

FIG. 4 shows, in the abscissa, the quotas owned by the client (customer owned quota), and in the ordinates, the quotas owned by the bank (column of table 4: bank owned quotas), it can be seen, as the months pass, that the quotas owned by the bank and by the client tend to have an opposite trend. Around the 21^{st} year, the moment arrives when the client's quotas begin to be more numerous than the bank's quotas.

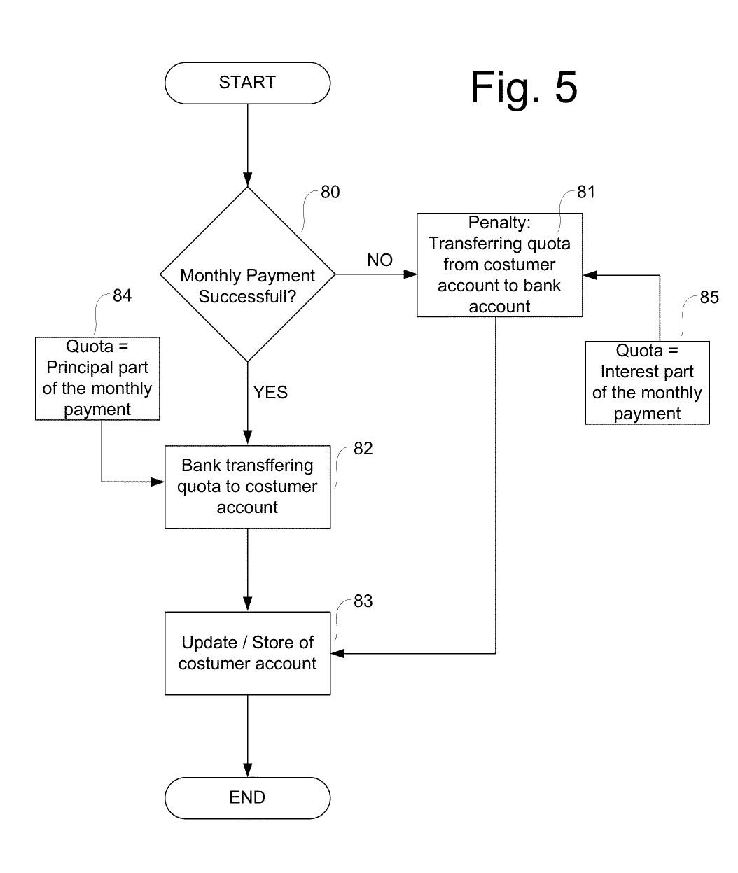

The computerized system (40, 41, 42, 43) uses these data to produce an agreement document (50), using a printer, between the parties, which regulates and disciplines at least the following aspects:
the acquiring owner must pay an installment whose value is communicated, every month, by the bank if the interest is of the variable type, or according to the reacquisition plan indicated above, if the interest is fixed.
Receiving, for each installment paid, a corresponding number of quotas or fractions calculated on the value of the capital part of the monthly installment of the amortization plan;
Being able to use the house for residential purposes following the payment of the monthly installment.
Being able to effect additional payments for the acquisition of quotas, which will reduce the amount of quotas to be reacquired.
Should the purchaser not be able to pay the installments for the redemption, for a number of months, he will have to leave the estate, and for each month of non-payment, the purchaser must return a quota or the relative fraction; the bank will transfer the quotas for the non-paid installments from the client's quota account to own account.
The quota(s) or fractions of the same transferred by the bank as penalty for the lack of payment of at least one monthly installment, preferably corresponds to the interest share of the non-paid installment, or, alternatively, with another counter-value agreed upon by the bank and client which can also include the capital part of the installment; the non-payment of one or more installments implies an extension of the months of payment or an increase in the subsequent quotas, according to the agreement between the parties. FIG. 5 indicates the block scheme which, at the condition that the payment of the monthly installment (80) has been paid, envisages the negative case of the penalty (81), or the transfer of quotas from the customer's account to that of the bank (82), updating and memorizing the transaction on the client's account (83). If the payment is successful, the bank transfers a quota or fraction from its account to the customer's account, which is updated and memorized (83). Block 84 show that in calculating the value of quota will be used the principal part of the monthly installment, in case of positive payment. In case of negative payment the value of quota is calculated in block 85 on the interest part of defaulted monthly installment.
The client will remain the owner of the quotas paid and, according to separate agreements regulated by separate contracts, will be able to exchange these quotas, through a website prepared by the bank or by an independent financial services company, within an exchange and information system on the prices of the quotas to which all property owners according to this method belong, or can belong; said plan subscribers, who intend to change house within the same city, within the same state or within the same nation or other nations which use this system and method, i.e. simply want sell his quotas and the repurchaising plan associated to his house.
For the whole duration of the contract, i.e. until the purchaser has reached full ownership of the property by acquiring all the quotas issued by the HPV and relating to the estate of the purchaser, the administration and control of the HPV, and therefore the relative estate, are effected by the bank, derogating from contracts which regulate membership within companies such as LLCs, which can be the preferential form of legal entity of the HPV. This measure is necessary for preventing the purchaser, once he has acquired the majority—i.e. 50%+1 of the HPV quotas—from controlling the property, at will, as he is the owner of the majority of the HPV quotas when structured in the form of an LLC, abusing the spirit of the acquisition method of the house according to the present invention.

The above method has various advantages: in short, it envisages a model of payment of monthly installments which can be comparable to a rent or mortgage installment, with the difference that whereas the monthly rent is lost, with this method, it is accumulated into ownership quotas of the estate, thus representing a form of saving and a capital accumulation represented by the estate. Compared to a traditional mortgage, the main advantage is to be able to use the property without requiring an actual loan from a bank to the purchaser of the estate and consequently without a an actual debt towards the bank. In this way, people with a low credit rating or low income, or with possible bankruptcy in progress, can have the property at their disposal with the simple possibility of effecting monthly installments for the estate. In addition, in the case of default which continues for several months, the estate is not subject to the process of foreclosure and is therefore not put up for sale by the bank to recover the residual value of the debt, but simply transferred to a new owner who will start a new plan according to this method or will take over the existing one by acquiring the quotas owned by the old defaulted owner.

In doing this, it is possible to include in the method contractual mechanisms which allow cases of devaluation or re-evaluation of the estate to be envisaged, where bank and owner can share or not risks and profits.

Another advantage of this system is the mobility it allows when a subject needs to move to another city or area of the same city, as often happens in a highly “movable” society, characterized by frequent transferals such the American society.

Thanks to the principle of the quotas owned, it is possible to establish an online exchange mechanisms, so that if a customer who lives in New York and owns a number of quotas of his estate, needs to move to Los Angeles, he can sell his quotas of the New York property and, with the same money, can acquire a certain number of quotas of an estate in Los Angeles, more practically and rapidly with respect to a traditional mortgage.

Whereas in the case of an estate purchased by means of a traditional mortgage, the client should first sell the property in New York, through an estate agent, pay the remaining debt to the bank and then, with the possible remaining capital, purchase an estate in Los Angeles, after searching for and signing a new contract for a mortgage with another bank. It is also possible to effect an exchange, but the two parties must have the intention of exchanging their respective properties. On the contrary, by using the system object of the present invention, thanks to the online exchange system, described hereunder, it is possible to sell the ownership quotas of an estate in New York to another person in New York, and look for a house in Los Angeles made available by a third person, using the accumulated quotas as down-payment to be paid for purchasing the new property. This idea, in fact, allows a property to be “movable” thanks to the concept at the basis of the present invention, centred on ownership quotas, as if they were company shares/securities. Consequently, the present invention allows “real estate” to become “movable property”.

For the functioning of this system, it is essential for the bank, in order to avoid excessive risks, to have a guarantee margin represented by the quotas owned by the customer and purchased at the beginning by down payment. If the market price of the estate has decreased, the bank will use the quotas owned by the client in default to face said decrease in the price Furthermore, as an additional clause of the contract, the bank can automatically and dynamically establish a guarantee, updated each month, equal to 20% or another percentage of the amount of the residual capital. Said residual capital, equal to the total residual quotas to be repurchased, changes every month, decreases when the installments are paid and increases when one or more installments are not effected. This further guarantee allows the bank a better management of possible estate and financial crisis as that of 2007-2008.

In addition, by design, the method and system presented herein is characterized by low risks for the bank, as in the case of default, the hypothesis of foreclosure is avoided and the customer can negotiate an extension of the reacquisition plan of the quotas. As can be seen, the quotas owned by the client can be used for immediately recovering the non-paid monthly installments and if these continue, evict the same and free the estate again, ready for a new subscriber; if the sales price of the estate to a new subscriber is lower than the initial one, the quotas accumulated by the client will be used, which the bank will take possession of on the basis of the contract, in order to compensate the difference in price.

Table 5 summarizes the situation of the plan seen in table 1, after 5 years of regular installments. The quotas accumulated are 20.84 to which the initial quotas of the down payment must be added, making a total of 80.24 quotas.

TABLE 5
Situation after 5 years

| | |
|---|---|
| Total payment | 107,880.00$ |
| Principal paid | 20,836.00$ |
| Interest paid | 87,082.00$ |
| Quotas acquired | 20.84 |
| Total quota (initial + acquired) | 80.84 |
| Value of quota owned | 80,836.00$ |
| Remaining quota value (to be acquired) | 279,154.00$ |
| Remaining quota number | 279.16 |

Tables 6 and 7 hereunder show the cases of devaluation and re-evaluation of a property purchased by means of the present method and system.

If a property is to be purchased according to the present method and this has a market value higher than that paid for the purchase, there is the situation shown in table 6. The estate in question which has a sales value of $400,000 determines an appreciation of the quotas of $8,921.78 for the quotas acquired by the owner, each of them having a value of $ 1,111.11 with respect to $ 1,000 of the original value. The remaining quotas, not yet acquired, generate an appreciation of $31,018.22.

The contract signed by the customer and the bank can establish a share of the profits in the case of appreciation, or the appreciation can be divided on the basis of the quotas actually owned.

TABLE 6
Sales after 4 years - Increase in value

| | |
|---|---|
| Property value | 400,000.00$ |
| Increase | 40,000.00$ |
| Initial quota number | 60,000.00$ |
| Capital acquired | 20,836.00$ |
| Total quota number | 80.84 |
| Value quota owned | 80,836.00$ |
| Initial quota value | 1,000.00$ |
| Quota value with revaluation | 1,111.11$ |
| Gain per quota | 111.11$ |
| Quota residual number | 279.16 |
| Value increase in residual quota | 31,018.22$ |
| Value quota owned | 89,817.78$ |
| Gain for all owned quota | 8,981.78$ |
| Gain for not owned quota | 31,018.22$ |

Table 7 shows the case in which, in the case of the sale of the property on the part of the client (to change house or move or anything else), there has been a decrease in the value of the estate with respect to the initial price. The estate has a market value of $320,000 with respect to $360,000 paid before, generating an overall depreciation of $40,000. In this case, each of the 360 quotas has a value of $888.89 causing a depreciation of the quotas owned by the client equal to $8,981.79 and $31,018.22 for the quotas owned by the bank. In this case, on the basis of the contract and guarantee margin, the bank can recover the appreciation on the quotas owned by the client, or share the loss with the client, in accordance with the agreement reached when the contract was signed.

TABLE 7
Sales after 5 years - Decrease in value

| | |
|---|---|
| Property value | 320,000.00$ |
| Decrease | −40,000.00$ |
| Initial quota number | 60,000.00$ |
| Capital acquired | 20,836.00$ |
| Total quota number | 80.84 |
| Value quota owned | 80,836.00$ |
| Initial quota value | 1,000.00$ |
| Quota value with devalutation | 888.89$ |
| Devalutation per quota | −111.11$ |
| Quota residual number | 279.16 |
| Value increase in residual quota | −31,018.22$ |
| Value quota owned | 71,854.22$ |
| Loss for all owned quota | −8,981.78$ |
| Loss for not owned quota | −31,018.22$ |

An expert in the field can easily see how it is possible, instead of having a system based on the reacquisition of HPV quotas, by means of monthly payments including both capital and interests, as if it were an installment of a mortgage, it is possible to introduce a concept of a rent (equivalent to a quota or all the interest allowing the bank to have some cash-flow) without there being any transfer of quotas, as this procedure contemplates the payment of the interests only. In short, with this method, the client suspends the reacquisition of the quotas and has a lighter monthly installment. The reacquisition of the quotas can start subsequently, according to the availability of the client. This procedure can be used when the client has difficulty in paying the whole installment. It is also evident that the bank which owns property possessed by HPV which does not have a client at that moment, can rent this property and have positive cash-flows thanks to the rental fees.

The alternative rental fee can be established on the basis of a fixed or variable interest rate equal to the remuneration of the residual value of the estate. The calculation basis would be the total of the values of the quotas owned by the bank when it has the option of using the rental fee instead of the installment. In this way, on the one hand, the remuneration of the bank of the capital on the residual total capital is guaranteed, and on the other, the client is offered the possibility of paying a lower monthly payment. If a client does not even pay the rental fee, the latter will be subtracted from the amount of quotas accumulated by the client.

A second, simpler implementation of the invention is that in which the bank grants the client a real estate loan and, instead of receiving a mortgage as guarantee, the bank obtains the quotas of the relative HPV as guarantee. Alternatively the bank purchases this quotas from the client giving to him the loan to acquire the house. In this way, the loan is registered in the client's name, who can therefore deduct the interests from his income declaration, like a traditional mortgage loan. The house however is in the name of HPV, as in the preferred implementation, with the same mechanism of reacquisition and transferring of quotas. In the same way in case of non payment the bank will take quotas back as in the first implementation. This second implementation is like a buyback of quotas performed by the client in force of repurchasing plan. The quotas are calculated in the same way as the first implementation, In this case the loan is in the name of the client, so that he can fiscally deduce the interest, whereas the loan of the bank (with the eventual down-payment of the client) is used for purchasing the estate and transferring its ownership to the HPV in use. Depending on the down-payment, which determines the number of quotas purchased immediately by the client, each time a monthly payment is made, the bank “grants” a quota or fraction of a quota to the client, who accumulates it in his own account.

If the client does not pay the monthly installment, the sanction and penalty mechanisms contemplated in the preferential implementation intervene i.e. the transfer of the quota to the bank, which, in this case, would mean re-obtaining a quota or fraction of the quota or more, until eviction for excessive and repeated default and the return of the estate to the market. This quota is calculated on the interest part of each month installment. This implementation can be effected in the same way with the help of a computerized system (40, 41, 42, 43) which, once it has received the client's input data (44), the estate data and applying the method for establishing the number of quotas, elaborates the number of quotas, the amount of the installment and prints an agreement (50) which is then stored in a computer; this document envisages the following:
the client accepts the financial obligation of a loan in favour of the HPV, in whose name the estate will be registered and the client will receive quotas of said HPV on the basis of the down-payment effected; the bank will take the rest of quotas as guarantee against loan to the client.
the client undertakes to pay a monthly installment to the bank, calculated by the computer with an amortization plan;
the client will receive a quota or fraction or more quotas of the HPV in whose name the estate used by the client is registered, every time he succeeds in paying a monthly installment to the HPV;
the client accepts that, in the case of lack of payment of one or more installments, the bank will transfer one or more quotas or fractions of the HPV as guarantee equal to the value of the interest portion of the monthly installment;
acceptance of the devaluation and re-evaluation mechanisms contemplated by the preferential implementation and negotiated between the bank and the client.

The use of this method is for the acquisition of a new house and can be suitable for the exchange and transfer system of quotas contemplated by the telematic marketplace as in the first implementation.

For the sake of brevity, further considerations which could be made, will be omitted; an expert in the field will be able to easily implement this second implementation according to the objectives and effects of the first implementation, as in the flow diagrams and procedures seen for the first implementation.

A third implementation of the present invention is to use the present method and system for all mortgage loans, in particularly in which there is insolvency on the part of the borrower and the risk of foreclosure, or need to renegotiate, by converting said loans into reacquisition plans according to the present invention, thus avoiding foreclosure, allowing the budget of the banks to be readjusted, and a more affordable installment.

As we have seen, if the owner who purchases a house according to this method is not able to pay the monthly installment, i.e. he is not able to reacquire the quotas in accordance with the established plan, the bank can effect several measures to protect its interests. When there are one or more unpaid installments, the bank will effect the transfer procedure of the quotas for each unpaid monthly installment. Should the default continue, the bank can simply evict the owner—on the basis of the contractual agreements—and find a new owner to replace the previous one, i.e. he will continue the acquisition plan of the house according to the present method. The risk for the bank is limited with respect to traditional mortgages, as the bank, by contract, will always be the owner of the house until the latter is totally reacquired, i.e. until all the HPV quotas have been reacquired by the client/owner. The greatest burden for the bank is to find a new owner or person to take over the plan, through the marketplace and thanks to the particular characteristic of this system, however, it will be easy to find people who need a house and want to use this system instead of purchasing it through a traditional mortgage based on a loan or instead of being simple tenants, as this system and method is more accessible with respect to acquisition through an estate mortgage.

Furthermore, in the case of a traditional mortgage, a low credit rating of the borrower implies a higher interest rate, whereas, using the present method, there is no financial risk for the homeowner as there is no loan towards the latter (except for the second implementation where the loan is backed by a HPV's quotas), but only the capacity of reacquiring the quotas. The interest rate will therefore normally be lower also for people with a low credit scoring.

The conversion of a loan into a reacquisition plan according to the present invention has benefits for the bank. A mortgage loan of 100,000 $ is registered by the bank as a credit with respect to the client and is therefore subject to the risk of insolvency of the client. This credit is registered in the assets of bank accounts, under the item credits towards clients, as per table 2.

With this system, on the contrary, at the initial moment of the plan, a house with a value of 120,000 $ is considered an asset owned by the bank through the HPV quotas in whose name the estate is registered, and is therefore situated among the assets, but as “financial participation” or “financial instruments” and as the client gradually buys his quotas, the value of this asset diminishes—as the HPV quotas, owned by the bank decrease—until total reacquisition on the part of the client.

Consequently, also from a patrimonial point of view of the banks, the present method (whatever is the implementation used) has these advantages and does not imply the implementation of costly write-offs, as were effected, on the contrary, during the crisis of 2008-2010, with the result that, due to the numerous insolvencies of the clients, the bank accounts caused the technical insolvency of many credit institutions, due to so-called “mark-to-market” account methods which impose the use of market value criteria for determining the value of some account items. Due to the introduction into the market of numerous properties coming from foreclosure procedures, there was an increase in the offer of estates with a decrease in the cost of the latter, thus further depressing the estate market and consequently the accounts of financial institutions. The insolvency problems of some banks derived from the inability to suitably price the values of the subprime mortgages (the so-called toxic assets), consequently leading to technical failure, not due to lack of liquidity but as a result of the devaluation of these mortgages and the inability to establish their exact value. It is therefore evident that this system, in cases of non-payment, does not mean revocation and devaluation of the credit, but the recovery of the quotas equivalent to non-paid installments and the search for a new owner who acquires the estate by means of the present method and system. In the present economic situation, a possible diffusion of this system and its massive development could lead to a regeneration of the estate market, the construction of new houses, which will be financed by this system, or an increase in property buying and selling which would allow an increase in the value of properties also for the present owners of houses purchased through mortgages. At the same time, in the case of recession or difficulty in acquiring the quotas by a large number of persons, there can be no systemic risk for the financial field, as it is not necessary to devaluate the loans (as these are not loans) but the bank could suffer temporary liquidity problems when various monthly installments are not paid by most of the clients of this acquisition plan. These liquidity problems can be short-term and it should be pointed out that, from a patrimonial point of view, there will be no imbalance as the unpaid monthly installments will return to the banks in the form of HPV quotas and will represent income (not cash based) for the bank: therefore, whether the bank collects the cash payment (the monthly installment) or obtains a quota or a fraction of it equivalent to the interest part of installment, this method allows the bank, in any case, to have an income. If a market of HPV quotas and securization develops, the bank, in order to face a temporary liquidity problem, can simply sell quotas and assets based on HPV and the present method.

This third implementation is effected by a computer and a printer for converting a mortgage into a reacquisition plan according to the present invention, are the following:

An agreement is stipulated between the bank and the loan nominee, produced with the help of a computer and a printer, which comprises transforming the loan agreement into a reacquisition plan in accordance with the present method.

The property is transferred from the owner of the house (or the borrower of the original loan) to the HPV entity indicated by the bank. On the basis of the value of the loan and its duration, the HPV will be subdivided into a certain number of quotas. The former borrower will receive a congruous number of quotas, equal to the value of the down-payment and of the capital which has matured up to the moment of conversion. The remaining HPV quotas will be owned by the bank.

In order to establish the price at which the conversion will take place, one of the following options can be considered, according to the convenience and the conditions of the property market:
a) the original price of the loan
b) the present market price of the estate
c) an arbitrary price between the original price of the loan and the present market price.

In selecting which price to adopt, possible differences between the original value and present value must be considered. The conversion to the original price of the loan (a) is correct if there is no significant difference between this and the present property value, particularly if this is a certain percentage lower than the initial value of the loan. In this case, problems of accounting and prudential principles for the account items arise. It is important, on the one hand, for the client to have a certain percentage of the total of the quotas and, on the other, for the bank to be able to use the latter as collateral security in the case of further devaluation of the estates and in the case of delay in payments on the part of the client, in order to re-benefit from the quotas or fractions for the months of delay. When the current market price is higher than the loan, the bank will be able to use the difference between the current value and loan value to the advantage of the HPV quotas held by the client.

The whole amount established is subdivided into certain quotas. 360 quotas are assumed for a property whose accepted value for the transaction is 300,000 $, so that each quota has a value of 833.33 $. The initial down-payment and the paid installments of original loan, form a capital of 100,000 $ which grants the right to receive 120 quotas of the HPV owner of the house. The financing of the remaining quotas to be purchased is effected by the bank on the remaining part (200,000 $), which converts the residual capital of the loan into relative HPV quotas. At the moment of the conversion, it will be possible to extend the reacquisition period or change the interest rates or introduce other conditions agreed on between the parties.

Once the agreement has been signed, the loan ceases to exist as a result of this agreement and the client's engagements are those contemplated by the reacquisition plan mentioned above. The bank can therefore cancel the credit from the client (credits towards clients) and can register in the assets “financial instruments” or “marketable securities”, the value of the HPV quotas in his possession.

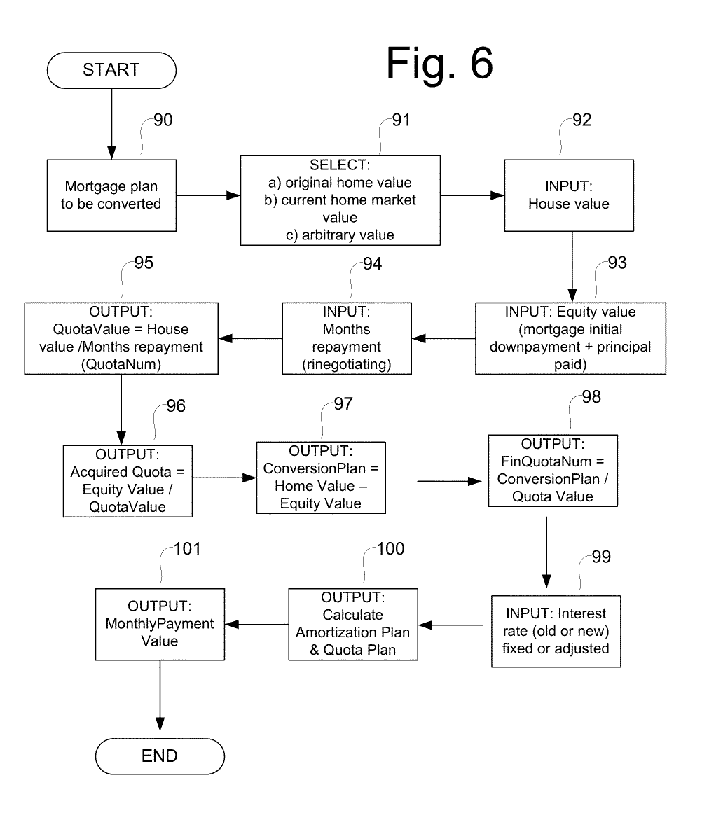

FIG. 6 represents a block scheme for the conversion of a loan into a reacquisition plan according to the present invention. The loan to be converted (90) can be in default or requires a reconversion, the price of the estate to be considered is selected (91), and this can be the original value (a), the current market price (b) or an arbitrary value (c) agreed upon by the parties. The selected value (House value) to be used is inserted (92), the Equity value of the house is calculated (93), i.e. adding what has been paid so far as capital during the initial mortgage loan repayment, and the value of the initial downpayment at the time of the loan. The re-payment months (94) of the conversion plan are subsequently inserted, following renegotiation of the terms of the loan to be reconverted, for the sake of convenience, the months of re-payment determine the number of quotas into which the HPV estate must be divided. In 95 the value of each quota (QuotaValue) is calculated, dividing the selected value of the house (House Value) by the number of months or the number of quotas (QuotaNum) which has been established. The computerized system returns the quantity of the Acquired Quotas (96) dividing the Equity value by the value of each quota (QuotaValue), whereas the amount for financing (ConversionPlan) the acquisition (97) of quotas is obtained by subtracting the Equity value from the established value of the house (Home Value). The financing amount is converted into quotas (98) (FinQuotaNum), dividing the financing amount (ConversionPlan) by the unitary value of the quota (QuotaValue). The insertion of the interest rate (99) subsequently allows the amortization plan and quota reacquisition plan to be calculated and obtained (100), as shown in table 4. The amount of the monthly installment of the reacquisition plan, according to the present invention, is then established (101), following conversion of a traditional mortgage.

By using this method and system, it is not even necessary to effect complex securization and similar instruments such as ABS (Asset Based Securities), CDO (Collaterized Debt Obligation) as it is not necessary to trans-form the mortgages into “securities” as the reacquisition plans are already Securities, i.e. the HPV quotas are Securities and can be exchanged by the banks carrying with them the reacquisition obligations on the part of the house owner/renter. Should synthetic instruments which include these Securities be created, the same can be produced by creating financial instruments “which contain” homogeneous reacquisition plans or which have a diversified or homogeneous risk profile and geography.

In this way, banks can place their reacquisition plans to third investors, receiving liquidity to effect new reacquisition plans. Contrary to the synthetic instrumentations ABS, CDO, which, de facto, were obligations, structured on a set of loans, which could have a high interest in relation to the risk of the subordinate but high-risk loans, as has been seen, in the case of synthetic instruments of reacquisition plans based on the present system, the rates would be lower but, at the same time, they would have a lower risk, due to both the direct guarantee represented by the HPV quotas and also because the interest rates applied for financing the reacquisition of quotas would, in turn, be lower. In this sense this invention helps to stabilize the interest rates of estate operations, reducing the risks for the entire system and for all the participants, specifically thanks to the fact that there is a direct and ready to marketable collateral, represented by the HPV quotas which remain the property of the bank or financer, until they are gradually redeemed.

This method, no matter how it is implemented, either for the acquisition of an estate or for the conversion of a mortgage, also contemplates and handles cases in which restructuring and improvement works are necessary or are effected on the estate. If these works are required initially, when the estate is purchased according to this system, the same can be financed by the bank and will involve an increase in the monthly rate and the unitary value of the quotas. If, on the contrary, they are effected after the purchase and are financed by the client, the bank, in order to include these positive variations which increase the value of the estate and consequently the HPV, will increase the number of quotas equal to the amount of the restructuring expenses and will transfer them to the client.

When the restructuring is effected after the purchase and requires a financing from the bank, this financing will be added to that already underway, increasing the value of the monthly installment and increasing the value of the residual quotas or increasing the number of quotas, so that the amount of the installment remains the same, or the plan is extended. If a contrary case occurs, due to negligence, damage not covered by the insurance or other negative events which cause a loss in the value of the property, the bank will effect a transfer of the quotas owned by the client until the damage or the devaluation has been compensated. The client will then reacquire said quotas and will accept an extension of the reacquisition plan or an increase in the monthly installments.

A fourth implementation of this method may not only be used for acquiring a house, but using the securitization of house in an HPV with quotas. By doing so it is possible to use the quotas as guarantee or collateral in a large number of loans: business loan, student loan, car loan, and for all financial need where a collateral is required. Once the house is owned by HPV, part of the quotas of HPV may be used as collateral for loans. The guarantee quotas are transferred from borrower account to bank account once the loan will be obtained. The borrower will buy back the quotas using the repurchasing plan method presented above. For the sake of simplicity the entire process of this fourth implementation will not show, but is quite similar to the process of the first implementation. A person skilled in the art may easy understand how to perform this implementation by adapting the original method.

The HPV entity can be registered as a LLC, a Limited Liability Company or it can be a LLC Series, or a particular form of LLC contemplated in the State of Delaware and other states ((Illinois, Iowa, Nevada, Oklahoma, Tennessee, Texas, Utah and Wisconsin) which allows a main unit and a whole series of subordinate units (Series) in whose name the single properties are registered, so that the management costs for the bank can be reduced with respect to the costs for separate LLCs. According to the law of Delaware, in fact, each Series is juridically considered independent of the other Series, with the possibility of having different members (the owners) for each Series and different assets, and, from a patrimonial point of view, each Series is considered independent of the others. In this way, it is possible to issue an arbitrary number of quotas on the basis of the values of the single properties and reacquisition plans suitable for each client, so that each quota corresponds to a membership unit of a LLC or a Series of LLCs. Alternatively, a further form for implementing the plan is to use a vehicle such as HPV, a specific company for this, assisted by a bank or financial institution which acts as HPV, in whose name various estates belonging to different clients are registered, using the following plan. In this case, the quotas are not representative of the capital of the HPV but are fictitious and purely accounts, referring to a contract, obtained using computerized systems, the regulations and specific agreements being in the spirit of the present invention. In this case, the ownership of the estate will be transferred by the bank to the client once the latter has completed the reacquisition of all the quotas. Once this system is in wide use, it will also be possible for certain states and jurisdictions to create specific special legal entities according to the spirit of the present invention, so as to allow the division of the quotas into a variable number and be specific for managing estates not only for residential but also for commercial or industrial purposes, to which the present method can be applied.

Thanks to the fact that the estate is in the name of a HPV, this method also allows, at the end of the payment of the reacquisition plan of the quotas, the full ownership of the HPV in favour of the owner. The latter can continue to maintain the ownership of the estate through the HPV or transfer the estate from the HPV to himself or to another person. Furthermore, the division of the estate into quotas allows the sale of the quotas to another owner, by simply transferring the HPV quotas to the latter. It is also extremely useful in the case of inheritance as the ownership of the estate is already divided into quotas which can simply be assigned to the heirs, or, in the case of separation between spouses, the quotas can be easily shared and transferred. Furthermore, the creation of a market of HPV quotas can give these assets a “liquid” value as a means of payment or as a financial asset, and can be offered as a guarantee for having access to further loans. This method and system also has the advantage of being extremely practical in all cases of divorce or separation so that in this event the distribution of the property is effected by sharing the quotas and allowing one or both to use these quotas within the computerized exchange system of quotas.

A single HPV can also be used for a number of properties, using the principle of joint-stock companies or entities whose property is represented by shares, so as to reduce the administration and management costs deriving from the use of various HPVs, such as LLCs or LLC Series.

In this implementation, the HPV is a joint-stock company or with a variable capital or a real estate fund, in whose name the properties purchased are registered, when new estate acquisition plans are signed by new purchasers.

In the hypothesis of a single HPV, with the capital represented by shares, for various properties, there is the problem of correctly pricing the quotas and ensuring that certain quotas correspond to a certain estate, and introducing protection mechanisms of the assets, so that in the end, if he has paid all of the installments, the client will own his estate.

The use of a single HPV requires that shares of the company be assigned to the clients as they effect the monthly installments, following the credit and penalty procedures as with the previous implementation. In order to simplify the accounting operations, the shares of this HPV can also be of a different class or series, so that each class of stock represents the capital of the equivalent of an estate. For indicating one series with respect to another, a progressive numbering or the letters of the alphabet or a mixture of both can be used for univocally indicating the class of shares, so as to associate the corresponding estate for each reacquisition plan. The quotas for each property will be transferred each month, represented by the shares of the relative class, associated to a property, until the transfer has been completed. The use of different classes avoids having to make calculations for adapting the value of the shares already issued, in the case of the issuing of shares for a new property which is added to the fund, when a single class of shares is used. This HPV would specifically act as an estate investment trust, but the use of different classes allows a better separation of the single estate assets and at the same time avoids calculations for adapting the price of each share each time a new estate is added in the hypothesis of a single class/series of shares for all the properties. It is evident that, by issuing a new series or class of shares for each estate, the problem does not arise, as the estate will refer to that class/series and to the capital of that class and consequently the relative shares will represent the value of the estate. Substantially, there is property segregation as in the case of a LLC Series, with the advantage of assigning the equity of each class of shares to a specific estate. This equity is composed of the quota paid by the bank and the down-payment of the client.

The remaining part of the system and method for the reacquisition and use for converting a loan, can be perfectly adapted to this implementation with a single HPV which allows the objectives of the present invention to be achieved. At the end of the payment/reacquisition of all the shares, the estate is transferred from the HPV to the client.

One of the advantages in dividing the value of a property into various quotas is that the quotas can be exchanged between different subjects. Each owner of a house according to the present system, who wishes to change house or move to another town, can exchange his quotas or sell them on an online marketplace, i.e. an Internet site which collects and shows the estates, whose quotas are put on the market by the current owners.

To do this, a website can be used for each house owner who wishes to sell or exchange the quotas of his own house with those of another owner, with the relative plans for the reacquisition of the quotas, according to the present method. This website created through suitable software application and hosted on a server of the internet network or another telematic network, contains the following sections:
user area: which indicates the data of the owner
estate area: which shows the data for identifying the estate, the planimetry, photos, cadastral surveys, a link with a geo-localization and visualization system of the estate on maps
repayment plan area: which shows the historical cost of the estate, the number of quotas into which the estate is divided, the number of quotas owned, their value and the remaining value of the quotas to be acquired to end the plan, indicating the net cost without interest, and total cost including interest
the current value of the estate, calculated by means of an evaluation by an expert or automatically calculated using a price index of the properties, according to the type of property and residential area and other useful characteristics which determine the value of an estate, or by means of other arbitrary criteria for determining the price.
a search engine which allows the estates present on the marketplace to be sought by type, city, value and other parameters essential for the search for properties on sites containing estates for sale.

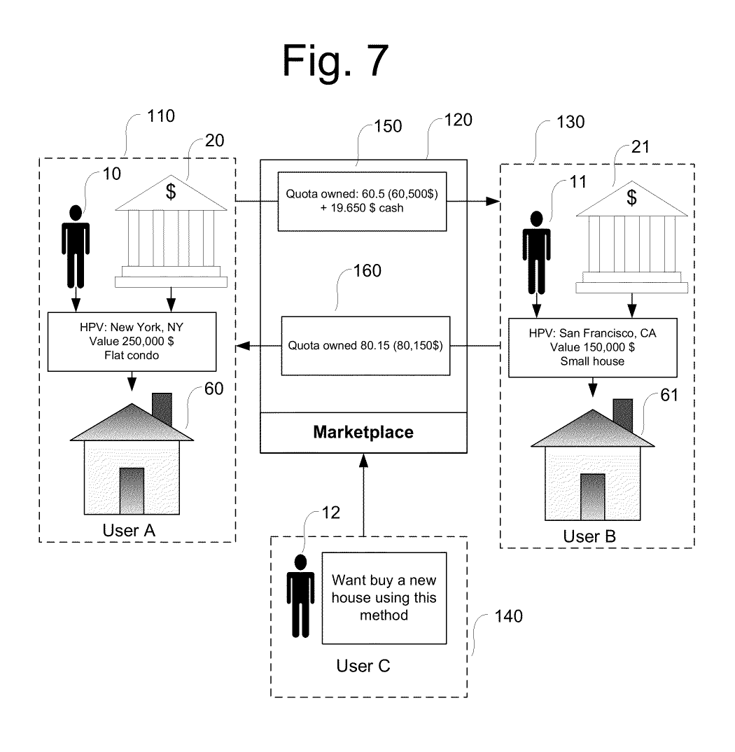

This data can be acquired directly from the data of the bank which has granted the acquisition plan according to the present method, by means of an exchange of data between the marketplace website and the informative system of the bank, once the owner has communicated to the bank—also through his own online account—his intention of selling or exchanging his quotas by putting them on the market. With the sale, the owner sells his own plan, i.e. his house, with the benefit of possible increases in value or facing a possible loss in value, like traditional methods for the purchasing of an estate (loan, leasing, cash payment), by liquidating the quotas in his possession. In FIG. 7 the user (10) A (box 110) owner of the estate (60) sells to the user (11) B (box 130) the quotas owned and accumulated in his possession and the user B takes over in the plan for the reacquisition of the estate, according to the system and method described herein. In the exchange effected by means of the marketplace (120), user A will transfer to user B—once they have accepted either through a computer or by signing a document relating to the transaction—the quotas in his possession (150) of the estate 60 of box 110 and user B will transfer to user A the quotas in his possession (160) of the estate 61 of box 130, i.e. the quotas of the relative HPVs. In effecting the exchange, increases or decreases in the values of one or both of the estates can be considered by re-evaluating or devaluating the value of the single quotas for each HPV, this operation being effected by the bank when the estate is initially listed on the marketplace (120) for sale, as in table 6 and 7. If the value of the quotas exchanged is different, as indicated in box 150 and box 160, the user A, in transferring his quotas (150), also adds the difference in cash in order to face the requirement of the quotas (160) of the user B (130). If there is no possibility of effecting an exchange with another user, the user A will obviously put his own quotas of the plan up for sale (Sale), and a user (12) C (box 140) will purchase it, and with the revenue of the sale of the quotas, the user A will buy another estate, or a certain number of quotas of the relative HPV, through the marketplace (120).

The subjects participating in the marketplace (120) can belong to two main categories: internal or external (user A and B). The internal subjects are all those who have offered their own estate purchased by means of the present method, for sale and/or for exchange. The external subjects (user C, box 140) are all those external to the system, i.e. not owners of quotas or property according to the invention, but who intend to purchase an estate, or the exchange quotas of internal members, according to the present purchasing method and system.

It is evident that the marketplace (120) will act as a property search site, like analogous internet systems and, as a further benefit, will also offer a saving thanks to the reduction in brokerage costs of real estate agents or other intermediaries, also telematic, thanks to the price information, sale or exchange of quotas, thus reducing transaction costs: at the same time, it is not even necessary to pay the registration or property transfer taxes as there is no transfer of estate—which remains in the name of the HPV—but of the owners of the quotas of the relative HPV, which can be easily effected by means of a simple transfer agreement of the HPV quotas.

1. Method realized by means of a computerized system which allows to produce contractual documents for implementing a gradual repurchase plan of an estate, which is put in a legal entity's name (house property vehicle), whose capital is represented in quotas; said quotas being transferred by the bank, owner of the legal entity and owner of the estate, to the purchaser according to a gradual repurchase plan. Said method provides the step of the gradual purchase of such quotas, upon payment of a monthly installment, each comprising a part of principal and a part of interest up to reach the full possession of the whole quotas of the legal entity owner of the estate; said part of principal corresponding to the value of the quota or quota fraction transferred by the bank to the purchaser.

2. Method according to claim 1, wherein the purchaser can leave an initial deposit (down payment) and obtain a number of quotas of the legal entity owner of the estate.

3. Method according to claim 1, wherein by means of a computer system, the quotas are transferred from the bank account to the purchaser one, wherein the value of the quota or quota fraction transferred is preferably equal to the principal part of the monthly installment calculated by means of a computerized system by using a method of constant or variable installment amortization with respect to the capital destined by the bank to finance the estate purchase.

4. Method realized by means of a computerized system according to claim 1 which allows to calculate the gradual repurchase plan, the number and the value of the quotas in which the legal entity capital is divided, which comprises the following steps:
a. introducing the house value
b. introducing the number of the capital quotas of the legal entity, which can be preferably equal to the number of months during which the total quotas are to be repurchased or to other arbitrary value
c. the computer calculates the quota value by dividing the estate value by the number of the quotas
d. it is introduced the amount of the down payment
e. a number of quotas is assigned to the purchaser dividing the down payment by the quota value,
f. the computer calculates the number of quotas which will be financed by the bank (i.e. acquired) by subtracting the quotas possessed by the purchaser from the whole quotas,
g. the value of the plan is calculated by multiplying the number of the financed quotas by the unitary value,
h. it is introduced a fixed or variable interest rate
i. an amortization plan, preferably of French type, about the value of the purchase plan financed by the bank, is calculated, printed or visualized in video, which comprises
for each month the value of the quota or of the quota fraction corresponding to the principal part of each monthly installment.

5. Method according to claim 1, wherein in the contractual document, the purchaser agrees about that in case of nonpayment of at least an installment, the bank, by means of a telematic system, transfers one or fractions or more quotas of the purchaser property from his account to its own account; the reversed quotas being calculated, preferably, so that they are equivalent to the interest part of each nonpaid monthly installment.

6. Method according to claim 1, wherein the contractual document provides that in case of sale of an estate purchased according to the present system and with a not-completed repurchase plan, if the sale price is lower than the initial one and such that it results in a capital loss and a depreciation of the unitary value of the quotas, the bank takes the accumulated quotas of the purchaser to compensate the value loss relative to the quotas possessed or by means of other form of loss sharing, stipulated by the parties.

7. Method according to claim 1, wherein the contractual document provides that in case of sale of an estate purchased according to the present system and with a not-completed repurchase plan, if the sale price is greater than the initial one, the consequent capital gain and increase in value of the quotas is divided proportionally to the quotas possessed by the bank and purchaser or by means of other form of gain sharing, stipulated by the parties.

8. Method according to claim 1, wherein the legal entity is a capital company as a LLC or LLC series or a public limited company or other form of legal entity apt to realize the method according to claim 1.

9. Method according to claim 8, wherein if the legal entity is a public limited company, for each estate is used a specific class of stock with segregated assets and quotas.

10. Method according to the claim 1, wherein the majority of the quotas (except those purchased according to claim 2) is owned by the bank, which purchases a certain number of quotas for financing the estate purchase.

11. Method according to claim 1, wherein the purchaser guarantees a credit line which is paid in favor of the legal entity owning the estate property, and the purchaser receives the property of the quotas, while the bank obtains under guarantee due to the credit line, the quotas of the purchaser. The bank will remove the guarantee by transferring for each paid installment the relative quota or quota fraction according to claim 3 or which will obtain others in case of nonpayment according to claim 5.

12. Method according to claim 1, wherein to the value of the monthly installment can be added annual costs distributed in each installment, the costs being:
national taxes on the house property
house insurance costs
management and administration costs of the legal entity
any other useful and needed administrative and instrumental cost.

13. Method realized by means of a computer system according to claim 1 and preceding ones which allows to produce a contractual document in which it is stipulated the transformation of a mortgage loan in a gradual repurchase plan implemented according to the preceding claims and having the same reversing mechanism provided in claim 5, in case one or more installments is not paid, wherein:
a. the conversion value is determined by choosing between the original value of the estate at the time of the loan; the current market value; an arbitrary and negotiated value. Said value is introduced in a computerized system
b. the computerized system calculates the equity value i.e. the quotas to be assigned to the purchaser calculated on the basis of the initial down payment and of the accumulated principal of the paid installments of the original mortgage loan.
c. it is introduced the number of months of the repurchase plan duration and which determines the number of quotas in which the estate is divided
d. it is calculated the value of each quota, dividing the agreed estate value by the number of months of the repayment plan, i.e. the number of quotas in which the legal entity capital is to be divided
e. it is calculated the number of quotas acquired by the purchaser dividing the equity value by the unitary value of each quota
f. it is calculated the value of the conversion plan which will be financed by the bank by subtracting the entity value accumulated by the purchaser from the used estate value
g. it is calculated the number of quotas in which it is divided the bank financing dividing the value of the conversion plan by the unitary value of each quota
h. it is introduced the fixed or variable interest rate
i. it is calculated the new amortization plan and the amount of the monthly installment and the value of each quota or fraction thereof for each monthly installment of the plan is printed and visualized in video.

14. Method according to claim 1, wherein said method is applied to obtain financing using a property estate, wherein the property of said estate is put in a legal entity's name according to claims 8 and 9, and whose quotas can be used as guarantee or given directly to a bank, which will give a loan to the borrower applying the transfer method of the quota or fractions for each paid installment according to claim 3 or at the relative reversing according to claim 5.

15. Method according to claim 1 and the preceding ones which allows to exchange the quotas accumulated by a purchaser of a legal entity owner of an estate with those of another purchaser who has a repurchase plan relative to another estate according to the method of claim 1 by using an online marketplace system or other computerized system, by integrating the difference by cash and each purchaser taking the contractual duties of the relative exchanged plans.

16. Method according to claim 1, which allows to sell the quotas of a repurchase plan to another purchaser, by means of a paper document realized by means of a computer or a printer or to be sold by online marketplace.

17. Computer system operating as server on the Internet which allows to implement a marketplace of repurchase plans according to the method of claim 1 and preceding, which allows to exchange said plans between different subjects according to claim 15 or to sell said plans according to claim 16.

18. Marketplace system according to claim 17, realized by means of a software code executed by a computer connected to the Internet apt to provide a web page or in other format containing the following information:
a. user area: which indicates the data of the owner
b. estate area: which shows the data for identifying the estate, the planimetry, photos, cadastral surveys, a link with a geo-localization and visualization system of the estate on maps
c. repayment plan area: which shows the historical cost of the estate, the number of quotas into which the estate is divided, the number of quotas owned, their value and the remaining value of the quotas to be acquired to end the plan, indicating the net cost without interest, and total cost including interest
d. the current value of the estate, calculated by means of an evaluation by an expert or automatically calculated using a price index of the properties, according to the type of property and residential area and other useful characteristics which determine the value of an estate, or by means of other arbitrary criteria for determining the price, further comprising a search engine which allows the estates present on the marketplace to be sought by type, city, value and other parameters essential for the search for properties on sites containing estates for sale.
